(19) United States
(12) Patent Application Publication
(10) Pub. No.: US 2003/0073003 A1
(43) Pub. Date: Apr. 17, 2003

(54) Molybdenum oxide based cathode active materials

(76) Inventors: Jeremy Barker, Oxforshire (GB); M. Yazid Saidi, Henderson, NV (US); Jeffrey L. Swoyer, Henderson, NV (US)

Correspondence Address: VALENCE TECHNOLOGY, INC., 301 CONESTOGA WAY, HENDERSON, NV, 89015, US

(21) Appl. No.: 09/974,311

(22) Filed: Oct. 9, 2001

(51) Int. Cl. H01M 4/48; H01M 4/62; C01G 39/02

(52) U.S. Cl. 429/231.5; 429/232; 252/182.1; 423/606

(57) ABSTRACT

The invention provides lithiated molybdenum oxides useful as cathode (positive electrode) active materials in rechargeable batteries, especially in lithium ion rechargeable batteries. In one aspect, the invention provides lithiated molybdenum oxides, some of which can be represented by nominal formulas LiₓMoO₂ where x ranges from 0.1 to 2, and Li₄Mo₃O₈. The crystal structure of the lithiated molybdenum oxides of the invention is characterized as being in a hexagonal space group with unit cell dimensions in a determined range. In a preferred embodiment, the lithiated molybdenum oxides of the invention can be formulated with known materials to provide electrodes for electrochemical cells. The invention also provides rechargeable batteries made by combining one or more such electrochemical cells.

### FIELD OF THE INVENTION

The present invention relates to improved materials usable as electrode active materials and to their preparation.

### BACKGROUND OF THE INVENTION

Lithium batteries are prepared from one or more lithium electrochemical cells containing electrochemically active materials. Such cells typically include an anode (negative electrode), a cathode (positive electrode), and an electrolyte interposed between spaced apart positive and negative electrodes. Batteries with anodes of metallic lithium and containing metal chalcogenide cathode active material are known. The electrolyte typically comprises a salt of lithium dissolved in one or more solvents, typically aprotic organic solvents. By convention, during discharge of the cell, the negative electrode of the cell is defined as the anode. Cells having a metallic lithium anode and metal chalcogenide cathode are charged in an initial condition. During discharge, lithium ions from the metallic anode pass through the liquid electrolyte to the active material of the cathode whereupon they release electrical energy to an external circuit.

It has recently been suggested to replace the lithium metal anode with an insertion anode, such as a lithium metal chalcogenide or lithium metal oxide. Carbon anodes, such as coke and graphite, are also insertion materials. Such negative electrodes are used with lithium-containing insertion cathodes, in order to form an electroactive couple in a cell. In order to be used to deliver electrochemical energy, such cells must be charged in order to transfer lithium to the anode from the lithium-containing cathode. During discharge the lithium is transferred from the anode back to the cathode. During a subsequent recharge, the lithium is transferred back to the anode where it re-inserts. Upon subsequent charge and discharge, lithium ions are transported between the electrodes. Such rechargeable batteries, having no free metallic species are called rechargeable ion batteries or rocking chair batteries. See U.S. Pat. Nos. 5,418,090; 4,464,447; 4,194,062; and 5,130,211.

Known positive electrode active materials include LiCoO₂, LiMn₂O₄, and LiNiO₂. The cobalt compounds are relatively expensive and the nickel compounds are difficult to synthesize. A relatively economical positive electrode is LiMn₂O₄, for which methods of synthesis are known. The lithium cobalt oxide, the lithium manganese oxide, and the lithium nickel oxide have a common disadvantage in that the charge capacity of a cell comprising such cathodes may suffer a significant loss in capacity. That is, the initial specific capacity available (milliamp hours/gram) from LiMn₂O₄, LiNiO₂, and LiCoO₂ is less than the theoretical specific capacity because significantly less than 1 atomic unit of lithium engages in the electrochemical reaction. Such an initial capacity value is significantly diminished during the first cycle operation and such capacity further diminish in successive cycles of operation. For LiNiO₂ and LiCoO₂ only about 0.5 atomic units of lithium is reversibly cycled during cell operation. Many attempts have been made to reduce capacity fading, for example, as described in U.S. Pat. No. 4,828,834 by Nagaura et al. However, the presently known and commonly used, alkali transition metal oxide compounds suffer from relatively low capacity. Therefore, there remains the difficulty of obtaining a lithium-containing electrode material having acceptable capacity without disadvantage of significant capacity loss when used in a cell.

Lithiated molybdenum oxides of the present invention have not been used in lithium ion batteries. Huang et al. in J. Electrochem. Soc vol. 135, page 411 (1988) describe lithium insertion in MoO₂ to make a material characterized as LiMoO₂. However, the structure of the material is different from that of the lithiated molybdenum oxides produced by the reduction processes of the invention. Tarascon in U.S. Pat. No. 4,710,439 discloses for use in a lithium metal battery a cathode material of nominal formula LiₓMo₂O₄ where x ranges from 0.3 to 2. The materials of Tarascon are prepared by ion exchange from a sodium material and have a monoclinic structure. In U.S. Pat. No. 4,251,606 to Haering et al., a battery is described that contains an anode of lithium metal and a cathode made of MoO₂. During discharge, a portion x of lithium atoms can insert into the lattice of the cathode active material to form a substance with nominal formula LiₓMoO₂, which, as in Huang, has a lattice structure like that of MoO₂.

### SUMMARY OF THE INVENTION

The invention provides lithiated molybdenum oxides useful as cathode (positive electrode) active materials in rechargeable batteries, especially in lithium ion rechargeable batteries. In one aspect, the invention provides lithiated molybdenum oxides, some of which can be represented by nominal formulas LiXMoO2 where x ranges from 0.1 to 2, and Li₄Mo₃O₈. The crystal structure of the lithiated molybdenum oxides of the invention can be characterized as being in a hexagonal space group with unit cell dimensions in a determined range.

In one aspect of the invention methods are provided for producing the lithiated molybdenum oxides. The materials are synthesized by reacting a lithium source and a source of molybdenum in an oxidation state of +4 to +6, in the presence of a carbon reductant. During synthesis of the lithiated molybdenum oxides of the invention, molybdenum is reduced and carbon is oxidized, so that the molybdenum in the reaction product is in a lower oxidation state than it was in the starting material molybdenum source. The active materials of the invention contain molybdenum in an oxidation state of from +2 to less than +6. It should be noted too that the average oxidation state of molybdenum within a given compound can take on non-integer values within that range.

In a preferred embodiment, the lithiated molybdenum oxides of the invention can be formulated with known materials to provide electrodes for electrochemical cells. The invention also provides rechargeable batteries made by combining one or more such electrochemical cells.

### BRIEF DESCRIPTION OF THE DRAWINGS

FIG. 1 is x-ray diffraction data of LiMoO₂ made from MoO₃/Li₂CO₃/carbon.

FIG. 2 is current cycling results with LiMoO₂ in the positive electrode.

FIG. 3 is current cycling data of LiMoO₂ made from MoO₃/LiOHH₂O/carbon.

FIG. 4 is current cycling data of Li_{0.74}MoO₂ material.

FIG. 5 depicts x-ray diffraction data of MoO₂ prepared by carbothermal reduction with 25% excess carbon.

FIG. 6 is x-ray diffraction data of commercial MoO₂.

FIG. 7 is x-ray diffraction data of MoO₂ prepared by carbothermal reduction with 25% excess carbon.

FIG. 8 is x-ray diffraction data MoO₂ prepared by carbothermal reduction with 50% excess carbon.

FIG. 9 is x-ray diffraction data MoO₂ prepared by carbothermal reduction with 100% excess carbon.

FIG. 10 is x-ray diffraction data from LiMoO₂ made from MoO₂/Li₂CO₃/carbon (25% excess).

FIG. 11 is x-ray diffraction data from LiMoO₂ made from MoO₂/Li₂CO₃/carbon (100% excess).

FIG. 12 is current cycling data from LiMoO₂ made from MoO₂/Li₂CO₃/carbon (25% excess).

FIG. 13 is current cycling data of LiMoO₂ made from MoO₂/Li₂CO₃/carbon (100% excess).

FIG. 14 is electrochemical voltage spectroscopy of LiMoO₂ made with 100% excess carbon.

FIG. 15 is differential capacity data for LiMoO₂ made with 100% excess carbon.

FIG. 16 is current cycling data of Li_{0.85}MoO₂.

FIG. 17 is x-ray diffraction data of Li_{0.74}MoO₂.

FIG. 18 is current cycling data of Li_{0.74}MoO₂.

FIG. 19 is x-ray diffraction data of Li₄Mo₃O₈.

FIG. 20 is current cycling data of Li₃Mo₄O₈.

FIG. 21 is x-ray diffraction data of LiMoO₂ made from Li₂MoO₄ and Mo.

FIG. 22 is current cycling data for LiMoO₂ made from Li₂MoO₄ and Mo.

FIG. 23 is current cycling data for Li₄Mo₃O₈ made from Li₂MoO₄ and Mo.

FIG. 24 is cycling behavior of cells with LiMoO₂ as positive electrode active material.

FIG. 25 is cycling behavior of cells with carbothermally prepared Li₄Mo₃O₈

FIG. 26 is voltage-capacity response for a LiMoO₂ lithium ion cell.

FIG. 27 is differential capacity data for a LiMoO₂ lithium ion cell.

FIG. 28 is a voltage-capacity response for a Li₄Mo₃O₈ lithium ion cell.

FIG. 29 is a differential capacity data for a Li₄Mo₃O₈ lithium ion cell.

FIG. 30 is a diagrammatic representation of a typical laminated lithium-ion battery cell structure.

FIG. 31 is a diagrammatic representation of a typical multi-cell battery cell structure.

### DETAILED DESCRIPTION OF THE INVENTION

The lithiated molybdenum oxides of the invention can be represented by the empirical formula

Liₐ(Mo^{+d})_{b}O_{c} (I)

The oxidation state d of molybdenum in the lithiated molybdenum oxide can be from +2 to less than +6, desirably +3 to +5 and preferably +3 to +4. The variables a, b, c, and d satisfy the equation

a+bd=2c

so as to achieve charge neutrality.

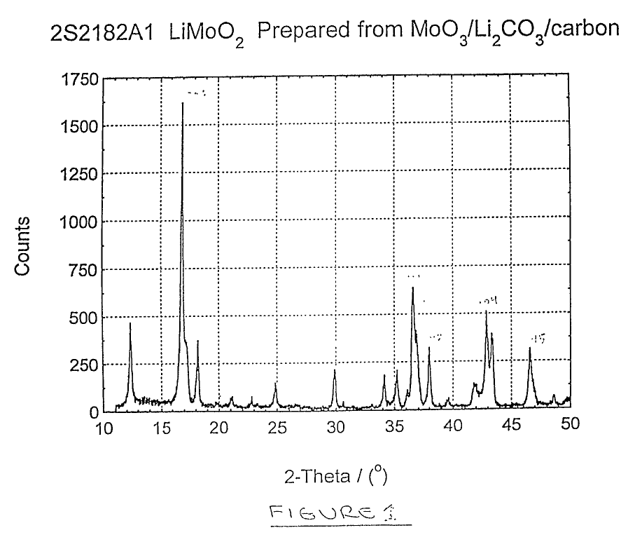

In one aspect of the invention, the active materials are lithiated molybdenum oxides with a common crystal structure, representing a series of related compounds sharing a similar lattice structure, where differences in empirical composition are accommodated in the structure by varying levels of population of anionic and cationic sites. The common crystal structure is demonstrated by the x-ray diffraction pattern of a number of the materials, such as described below in FIGS. 1, 10, 11, 17, 18, and 19. All show x-ray diffraction consistent with a structure having unit cell dimensions as illustrated in Table 1 based on a hexagonal space group. It is also possible to fit the x-ray diffraction patterns to a common monoclinic space group C2/m. The empirical representation of the active materials of the invention as given in Formula I can be “normalized” to two oxygens. That is, the lithiated molybdenum oxides of the invention can be represented by a structure Li_{a′}(Mo^{+d})_{b′}O₂ with (a′+b′d)=4. The relative values of a′ and b′ can be thought of as representing a fractional population of lattice sites in the crystal structure of an extended array.

Within the broad range of compounds generally represented by formula I, a number of compounds correspond to lithiated molybdenum oxides having a and b in simple ratios and c “normalized” to 2. For example, when a and b are both equal to 1, the lithiated molybdenum oxide is LiMoO₂, with molybdenum in an oxidation state of +3. When x is 1 and y is ¾, the formula represents compounds LiMo_{¾O}₂. This compound is more commonly written in least common multiple form as Li₄Mo₃O₈, with molybdenum in an oxidation state of +4.

As noted above, the variables a, b, and d can also take on non-integer values, or fractional values that do not reduce as readily to a least common multiple form. In one embodiment, when c is “normalized” to 2, the active materials of the invention can be expressed by the formula LiₓMoO₂, where x is greater than zero and less than 2. In a preferred embodiment, x is from about 0.3 to about 1.2, preferably from about 0.3 to about 1, while the average oxidation state of molybdenum is correspondingly from about 3 to about 3.7. For example, the synthesis of Li_{0.74}MoO₂ is described below, in which a is 0.74, and the oxidation state d of Mo is +3.26. Similarly Li_{0.85}MoO₂ is synthesized, in which a is 0.85 and d is +3.15. As described below, the invention provides a general method for synthesis of Liₐ(Mo^{+d})_{b}O_{c} (or Li_{a′}Mo_{b′}O₂) by varying the molar amounts of lithium, molybdenum and optional reductants, the values of a, b, c, d, a′, and b′ being constrained as noted above.

In another aspect, the active materials are reaction products of molybdenum compound and reducing carbon, containing carbon intimately dispersed through the reaction product. In this aspect, the active materials are prepared by reacting molybdenum compounds, lithium compounds, and at least a slight excess of reducing carbon. The reducing carbon forms nucleation sites for the formation of the reduced molybdenum compound during the reaction. After reaction, excess reducing carbon, usually in the form of elemental carbon, is dispersed throughout the reaction product.

The lithiated molybdenum oxides of the invention can be prepared with a carbothermal preparation method, using as starting materials a source of lithium and a source of molybdenum. Examples of lithium source are given below and include, without limitation, lithium acetate, lithium hydroxide, lithium nitrate, lithium oxalate, lithium oxide, lithium phosphate, lithium dihydrogen phosphate, and lithium carbonate, as well as hydrates of the above. Mixtures of lithium sources can also be used. Examples of molybdenum source are discussed below and include, without limitation, molybdenum dioxide, molybdenum trioxide, and molybdate compounds. Preferred molybdate compounds, used as the molybdenum source, include the alkali metal salts, such as sodium, lithium, and potassium, with lithium molybdate being preferred.

In the carbothermal preparation method, the starting materials are mixed together with reducing carbon, which is included in an amount sufficient to reduce the metal ion of one or more of the metal-containing starting materials. The reducing carbon in a preferred embodiment is elemental carbon, which is available as a powder that can be intimately mixed with the other powdered starting materials. Reducing carbon may also be supplied by a number of other organic materials that can decompose on heating to form an elemental carbon material that can take part in the carbothermal reaction. Such organic materials include without limitation, glycerol, mineral oils, cokes, coal tars, starch and other organic polymers that can form carbon material in situ on heating. In a preferred embodiment, the source of reducing carbon undergoes decomposition to elemental carbon in situ at temperatures below which the other starting materials react. The carbothermal conditions are set such as to ensure the metal ion does not undergo fall reduction to the elemental state. Excess quantities of one or more starting materials other than the reducing carbon may be used to enhance product quality. For example, a 5% to 10% excess may be used. The carbon starting material may also be used in excess. When the carbon is used in stoichiometric excess over that required to react as reductant with the molybdenum source, an amount of carbon, remaining after the reaction, functions as a conductive constituent in the ultimate electrode formulation. This is considered advantageous for the further reason that such remaining carbon will in general be intimately mixed with the product active material. Accordingly, excess carbon is preferred for use in the process, and may be present in a stoichiometric excess amount of 100% or greater. The carbon present during compound formation is thought to be intimately dispersed throughout the precursor and product. This provides many advantages, including the enhanced conductivity of the product. The presence of carbon particles in the starting materials is also thought to provide nucleation sites for the production of the product crystals.

The starting materials are mixed and then reacted together where the reaction is initiated by heat and is preferably conducted in a non-oxidizing, inert atmosphere, whereby the lithium and molybdenum combine to form the lithiated molybdenum oxide product. Before reacting the compounds, the particles are mixed or intermingled to form an essentially homogeneous powder mixture of the precursors. In one aspect, the precursor powders are dry-mixed using a ball mill and mixing media such as zirconia. Then the mixed powders are pressed into pellets. In another aspect, the precursor powders are mixed with a binder. The binder is selected so as to not inhibit reaction between particles of the powders. Therefore, preferred binders decompose or evaporate at a temperature less than the reaction temperature. Examples include, without limitation, mineral oils, glycerol, coal tars, cokes, starch, and other organic polymers that decompose to form a carbon residue before the reaction starts. In some embodiments, the binder used may be the same material used as the source of reducing carbon, as discussed above. In other embodiments, elemental carbon is used as a source of reducing carbon, and a binder is used in addition. In still another aspect, intermingling can be accomplished by forming a wet mixture using a volatile solvent and then the intermingled particles are pressed together in pellet form to provide good grain-to-grain contact.

Although it is desired that the precursor compounds be present in a proportion which provides the stated general formula of the product, the lithium compound may be present in an excess amount on the order of 5 percent excess lithium compared to a stoichiometric mixture of the precursors. As noted earlier, the reducing carbon may be present in stoichiometric excess of 100% or greater. A number of lithium compounds are available as precursors, such, without limitation, as lithium acetate (LiOCOCH₃), lithium hydroxide, lithium nitrate (LiNO₃), lithium oxalate (Li₂C₂O₄), lithium oxide (Li₂O), lithium phosphate (Li₃PO₄), lithium dihydrogen phosphate (LiH₂PO₄), and lithium carbonate (Li₂CO₃). Preferred lithium sources include those having a melting point higher than the temperature of reaction. In such cases, the lithium source tends to decompose in the presence of the other precursors and/or to effectively react with the other precursors before melting. For example, lithium carbonate has a melting point over 600° C. and commonly reacts with the other precursors before melting.

The method of the invention is able to be conducted as an economical carbothermal-based process with a wide variety of precursors and over a relatively broad temperature range. The reaction temperature for reduction depends on the metal-oxide thermodynamics, for example, as described in Ellingham diagrams showing the ΔG (Gibbs Free Energy Change) versus T (temperature) relationship. As described earlier, it is desirable to conduct the reaction at a temperature where the lithium compound reacts before melting. In general, the temperature should desirably be about 400° C. or greater, preferably 450° C. or greater, and more preferably 500° C. or greater. Higher temperatures are preferred because the reaction generally will normally proceed at a faster rate at higher temperatures. The various reactions involve production of CO or CO₂ as an effluent gas. The equilibrium at higher temperature favors CO formation.

Generally, higher temperature reactions produce predominantly CO effluent while lower temperatures result in relatively more CO₂ formation from the starting material carbon. At higher temperatures where CO formation is favored, the stoichiometry requires more carbon be used than the case where CO₂ is produced. The C to CO₂ reaction involves an increase in carbon oxidation state of +4 (from 0 to 4) and the C to CO reaction involves an increase in carbon oxidation state of +2 (from ground state zero to 2). Here, higher temperature generally refers to a range above about 650° C. While there is not believed to be a theoretical upper limit, it is thought that temperatures higher than 1200° C. are not needed. Also, for a given reaction with a given amount of carbon reductant, the higher the temperature the stronger the reducing conditions.

In one aspect, the method of the invention utilizes the reducing capabilities of carbon in a controlled manner to produce desired products having structure and lithium content suitable for electrode active materials. The method of the invention makes it possible to produce products containing lithium, metal and oxygen in an economical and convenient process. The ability to lithiate precursors, and change the oxidation state of a metal without causing abstraction of oxygen from a precursor is advantageous. The advantages are at least in part achieved by the reductant, carbon, having an oxide whose free energy of formation becomes more negative as temperature increases. Such oxide of carbon is more stable at high temperature than at low temperature. This feature is used to produce products having one or more metal ions in a reduced oxidation state relative to the precursor metal ion oxidation state. The method utilizes an effective combination of quantity of carbon, time and temperature to produce new products and to produce known products in a new way.

Referring back to the discussion of temperature, at about 700° C. both the carbon to carbon monoxide and the carbon to carbon dioxide reactions are occurring. At closer to 600° C. the C to CO₂ reaction is the dominant reaction. At closer to 800° C. the C to CO reaction is dominant. Since the reducing effect of the C to CO₂ reaction is greater, the result is that less carbon is needed per atomic unit of metal to be reduced. In the case of carbon to carbon monoxide, each atomic unit of carbon is oxidized from ground state zero to plus 2. Thus, for each atomic unit of metal ion (M) which is being reduced by one oxidation state, one half atomic unit of carbon is required. In the case of the carbon to carbon dioxide reaction, one quarter atomic unit of carbon is stoichiometrically required for each atomic unit of metal ion (M) which is reduced by one oxidation state, because carbon goes from ground state zero to a plus 4 oxidation state. These same relationships apply for each such metal ion being reduced and for each unit reduction in oxidation state desired.

It is preferred to heat the starting materials at a ramp rate of a fraction of a degree to 10° C. per minute and preferably about 2° C. per minute. Once the desired reaction temperature is attained, the reactants (starting materials) may be held at the reaction temperature for several hours. Although the reaction may be carried out in oxygen or air, the heating is preferably conducted under an essentially non-oxidizing atmosphere. The atmosphere is preferably essentially non-oxidizing so as not to interfere with the reduction reactions taking place. An essentially non-oxidizing atmosphere can be achieved through the use of vacuum or inert gases such as argon. Although some oxidizing gas (such as oxygen or air) may be present, it should not be at so great a concentration that it interferes with the carbothermal reduction or lowers the quality of the reaction product. It is believed that any oxidizing gas present will tend to react with the carbon and lower the availability of the carbon for participation in the reaction. To some extent, such a contingency can be anticipated and accommodated by providing an appropriate excess of carbon as a starting material. Nevertheless, it is generally preferred to carry out the carbothermal reduction in an atmosphere containing as little oxidizing gas as practical.

Advantageously, a reducing atmosphere is not required, although it may be used if desired. For example, the reaction may be carried out in the presence of reducing gases. Non-limiting examples of reducing gases include hydrogen, methane, ammonia, and carbon monoxide. Reforming gas, which is a combination of hydrogen in an inert gas such as argon or nitrogen may also be used.

After reaction, the products are preferably cooled from the elevated temperature to ambient (room) temperature (i.e., 10° C. to 40° C.). Desirably, the cooling occurs at a rate similar to the earlier ramp rate, and preferably 2° C./minute cooling. Such cooling rate has been found to be adequate to achieve the desired structure of the final product. It is also possible to quench the products at a cooling rate on the order of about 100° C./minute. In some instances, such rapid cooling (quench) may be preferred.

Active materials of the invention having molybdenum in the +4 oxidation state can be made in a single step without reduction by reacting a lithium source with a molybdenum source having a oxidation state of +4. See Examples 7 and 10 below, wherein lithium carbonate and molybdenum dioxide are reacted to form Li₄Mo₃O₈ with molybdenum in a +4 oxidation state. A molybdenum source with an oxidation state of +4 may also be used in a carbothermal reduction reaction to produce active materials having molybdenum in an oxidation state of less than +4. Examples 4 and 5 illustrate such a process, with molybdenum dioxide used as a molybdenum source.

In a preferred embodiment, the molybdenum source that is used to react with a lithium source is itself prepared from a second molybdenum source by carbothermal reduction. Examples 4, 5, and 7 illustrate a two-step process for making the active materials of the invention, wherein in a first step a second molybdenum source (represented in the Examples by molybdenum trioxide or MoO₃) is reduced in the presence of elemental carbon to form molybdenum dioxide (MoO₂). In a second step, the molybdenum dioxide from carbothermal reduction of the second molybdenum source can be further reacted with a lithium source either with (Examples 4 and 5) or without (Examples 7 and 10) a reductant comprising elemental carbon.

Molybdenum dioxide may also be produced from molybdenum trioxide by reacting with molybdenum metal as illustrated in Example 10. Whether molybdenum trioxide is to be reduced by molybdenum metal or by a carbon reductant, it is possible to use an excess of the reductant molybdenum or carbon respectively. In the case where carbon is the reductant, the excess carbon left at the end of the reaction is incorporated into the active material produced by subsequent reaction of the molybdenum dioxide with a lithium source. In such a situation, the active material containing excess carbon is compatible with the electrode composition which itself contains further carbonaceous material. Similarly, when molybdenum oxide is produced with an excess of molybdenum metal as reductant, the excess molybdenum metal is carried over into the active material produced by subsequent reaction of the molybdenum dioxide with a lithium source. The presence of excess molybdenum in the active material of the invention may be disadvantageous depending on the other aspects of the batteries made with the active material.

The lithiated molybdenum oxides of the invention can also be produced by reducing a molybdate with molybdenum metal. Such a reaction is illustrated in Example 11 where lithium molybdate, having molybdenum in a +6 valence state, is reduced with molybdenum metal to form an active material having molybdenum in a +4 valence state. As with reduction of molybdenum trioxide, the molybdenum metal in the reduction of lithium molybdate may be present in excess. As before, such excess is carried over into the active material produced by the reaction, which may as discussed above be disadvantageous depending on the characteristics of the battery. Active materials with molybdenum in the +3 valence state may also be made by reduction of molybdates with molybdenum metal (Example 8).

The lithiated molybdenum oxide active materials of the invention may also be produced by reacting a lithium source with a molybdenum source as discussed above, in the presence of a reductant comprising molybdenum metal. Such a scheme is illustrated in Example 9, wherein a general procedure is given for synthesis of active materials of empirical formula LiₓMoO₂. The molybdenum metal acts as a reductant and in a way analogous to the role of elemental carbon in the processes discussed above. In general, a source of lithium and a source of molybdenum is reacted in an appropriate stoichiometric amount to produce active materials made of lithiated molybdenum oxides according to Formula I given above. The stoichiometric amount of molybdenum metal used in the reaction is chosen to provide reducing power for the amount of molybdenum present in the molybdenum source. During the reaction, molybdenum metal is oxidized while Mo⁺ⁿ is reduced. Both types of precursor molybdenum end up in the reaction product. As with the other reductions with molybdenum metal and with elemental carbons described above, the molybdenum metal reductant may be used in a stoichiometric excess.

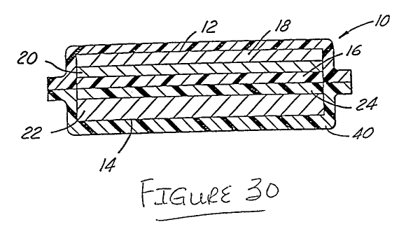

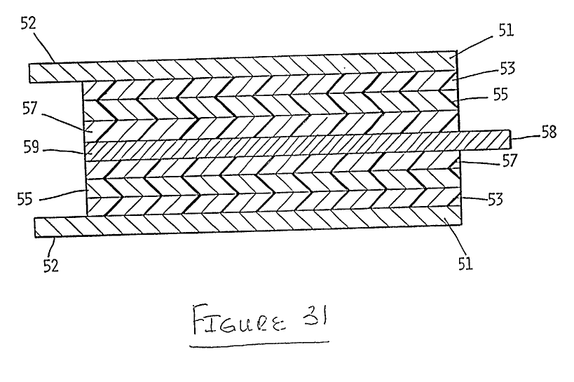

Typical cell configurations will now be described with reference to FIGS. 30 and 31; and such battery or cell utilizes the novel material of the invention. Note that the preferred cell arrangement described here is illustrative and the invention is not limited thereby. Experiments are often performed, based on full and half cell arrangements, as per the following description. For test purposes, test cells are often fabricated using lithium metal electrodes. When forming cells for use as batteries, it is preferred to use an insertion positive electrode as per the invention and a graphitic carbon negative electrode.

A typical laminated battery cell structure 10 is depicted in FIG. 30. It comprises a negative electrode side 12, a positive electrode side 14, and an electrolyte/separator 16 there between. Negative electrode side 12 includes current collector 18, and positive electrode side 14 includes current collector 22. A copper collector foil 18, preferably in the form of an open mesh grid, upon which is laid a negative electrode membrane 20 comprising an insertion material such as carbon or graphite or low-voltage lithium insertion compound, dispersed in a polymeric binder matrix. An electrolyte/separator film 16 membrane is preferably a plasticized copolymer. This electrolyte/separator preferably comprises a polymeric separator and a suitable electrolyte for ion transport. The electrolyte/separator is positioned upon the electrode element and is covered with a positive electrode membrane 24 comprising a composition of a finely divided lithium insertion compound in a polymeric binder matrix. An aluminum collector foil or grid 22 completes the assembly. Protective bagging material 40 covers the cell and prevents infiltration of air and moisture.

In another embodiment, a multi-cell battery configuration as per FIG. 31 is prepared with copper current collector 51, negative electrode 53, electrolyte/separator 55, positive electrode 57, and aluminum current collector 59. Tabs 52 and 58 of the current collector elements form respective terminals for the battery structure. As used herein, the terms “cell” and “battery” refer to an individual cell comprising anode/electrolyte/cathode and also refer to a multi-cell arrangement in a stack.

The relative weight proportions of the components of the positive electrode are generally: 50-90% by weight active material; 5-30% carbon black as the electric conductive diluent; and 3-20% binder chosen to hold all particulate materials in contact with one another without degrading ionic conductivity. Stated ranges are not critical, and the amount of active material in an electrode may range from about 25 to about 95 weight percent. The negative electrode comprises about 50-95% by weight of a preferred graphite, with the balance constituted by a binder. A typical electrolyte separator film comprises approximately two parts polymer for every one part of a preferred fumed silica. The conductive solvent comprises any number of suitable solvents and salts. Desirable solvents and salts are described in U.S. Pat. Nos. 5,643,695 and 5,418,091. One example is a mixture of EC:DMC:LiPF₆ in a weight ratio of about 60:30:10. This corresponds approximately to a 1M solution of LiPF₆ in an EC/DMC mixture.

Solvents are selected to be used individually or in mixtures, and include, without limitation, dimethyl carbonate (DMC), diethylcarbonate (DEC), dipropylcarbonate (DPC), ethylmethylcarbonate (EMC), ethylene carbonate (EC), propylene carbonate (PC), butylene carbonate, lactones, esters, glymes, sulfoxides, sulfonanes, etc. Mixtures of solvents include, without limitation, EC/DMC, EC/DEC, EC/DPC and EC/EMC. The salt content ranges from 5% to 65% by weight, preferably from 8% to 35% by weight.

Separator membrane element 16 is generally polymeric and prepared from a composition comprising a copolymer. A preferred composition is a 75 to 92% vinylidene fluoride with 8 to 25% hexafluoropropylene copolymer (available commercially from Atochem North America as Kynar FLEX) and an organic solvent plasticizer. Such a copolymer composition is also preferred for the preparation of the electrode membrane elements, since subsequent laminate interface compatibility is ensured. The plasticizing solvent may be one of the various organize compounds commonly used as solvents for electrolyte salts, e.g., propylene carbonate or ethylene carbonate, as well as mixtures of these compounds. Higher-boiling plasticizer compounds such as dibutyl phthalate, dimethyl phthalate, diethyl phthalate, and tris butoxyethyl phosphate are particularly suitable. Inorganic filler adjuncts, such as famed alumina or silanized fumed silica, may be used to enhance the physical strength and melt viscosity of a separator membrane and, in some compositions, to increase the subsequent level of electrolyte solution absorption.

Those skilled in the art will understand that any number of methods are used to form films from the casting solution using conventional meter bar or doctor blade apparatus. It is usually sufficient to air-dry the films at moderate temperature to yield self-supporting films of copolymer composition. Lamination of assembled cell structures is accomplished by conventional means by pressing between metal plates at a temperature of about 120-160° C. Subsequent to lamination, the battery cell material may be stored either with the retained plasticizer or as a dry sheet after extraction of the plasticizer with a selective low-boiling point solvent. The plasticizer extraction solvent is not critical, and methanol or ether are often used.

In a non-limiting example of the construction of one type of lithium-ion battery, a current collector layer of aluminum foil or grid is overlaid with a positive electrode film, or membrane, separately prepared as a coated layer of the dispersion of insertion electrode composition. The electrode composition generally contains a powder of the active material of the invention in a copolymer matrix solution, which is dried to form the positive electrode. An electrolyte/separator membrane is formed as a dried coating of a composition comprising a solution containing VdF:HFP copolymer and a plasticizer solvent is then overlaid on the positive electrode film. A negative electrode membrane formed as a dried coating of a powdered carbon or other negative electrode material dispersion in a VdF/HFP copolymer matrix solution is similarly overlaid on the separator membrane layer. A copper current collector foil or grid is ladi upon the negative electrode layer to complete the cell assembly. Therefore, the VDF:HFP copolymer composition is used as a binder in all of the major cell components, positive electrode film, negative electrode film, and electrolyte/separator membrane. The assembled components are then heated under pressure to achieve heat-fusion bonding between the plasticized copolymer matrix electrode and electrolyte components, and to the collector grids, to thereby form an effective laminate of cell elements. This produces an essentially unitary and flexible battery cell structure.

Examples of forming cells containing metallic lithium anode, insertion electrodes, solid electrolytes and liquid electrolytes can be found in U.S. Pat. Nos. 4,668,595; 4,830,939; 4,935,317, 4,990,413, 4,792,504, 5,037,712; 5,262,253; 5,300,373; 5,435,054; 5,463,179; 5,399,447; 5,482,795 and 5,411,820; each of which is incorporated herein by reference in its entirety. Note that the older generation of cells contained organic polymeric and inorganic electrolyte matrix materials, with the polymeric being most preferred. The polyethylene oxide of 5,411,820 is an example. More modern examples are the VdF:HFP polymeric matrix. Examples of casting, lamination and formation of cells using VdF:HFP are as described in U.S. Pat. Nos. 5,418,091; 5,460,904; 5,456,000; and 5,540,741; assigned to Valence Technology, Inc., each of which is incorporated herein by reference in its entirety.

As described earlier, the electrochemical cell operated as per the invention, may be prepared in a variety of ways. In one embodiment, the negative electrode may be metallic lithium. In more desirable embodiments, the negative electrode is an insertion active material, such as, metal oxides and graphite. When a metal oxide active material is used, the components of the electrode are the metal oxide, electrically conductive carbon, and binder, in proportions similar to that described above for the positive electrode. In a preferred embodiment, the negative electrode active material is graphite particles. For test purposes, test cells are often fabricated using lithium metal electrodes. When forming cells for use as batteries, it is preferred to use an insertion metal oxide positive electrode and a graphitic carbon negative electrode. Various methods for fabricating electrochemical cells and batteries and for forming electrode components are described herein. The invention is not, however, limited by an particular fabrication method.

The invention has been described above in relation to preferred embodiments. Further non-limiting examples of the lithiated molybdenum oxides of the invention are given in the examples that follow.

### EXAMPLES

The following Examples give the general reaction scheme and conditions used to make the active materials of the invention. Specific examples of synthetic materials are discussed below in relation to the data shown in the Figures.

### Example 1

### Direct Carbothermal Reduction of MoO₃ using Li₂CO₃ as Lithium Source to Produce LiMoO₂

Reaction assumes C→CO reaction (i.e. >650° C.)

Reaction

0.5 Li₂CO₃+1.0MoO₃+1.5C→LiMoO₂+0.5CO₂+1.5CO

0.5 g-mol Li₂CO₃ is equivalent to 36.95 g

1.0 g-mol MoO₃ is equivalent to 143.94 g

1.5 g-mol C is equivalent to 18.00 g

An excess of carbon—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive

(h) Powderize

(i) Optionally, re-pelletize and repeat steps (c) through (h) above

### Example 2

### Direct Carbothermal Reduction of MoO₃ using LiOH.H₂O as lithium source

Reaction assumes C→CO reaction (i.e. >650° C.)

Reaction

1.0LiOH.H₂O+1.0MoO₃+1.5C→LiMoO₂+1.5H₂O+1.5CO

1.0 g-mol LiOH.H₂O is equivalent to 41.96 g

1.0 g-mol MoO₃ is equivalent to 143.94 g

1.5 g-mol C is equivalent to 18.00 g

An excess of carbon typically 0-100% mass excess, may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above.

### Example 3

### Direct Carbothermal Reduction of MoO₃ using Li₂CO₃ as Lithium Source to Produce LiₓMoO₂ (0<x<2). For example, to make Li_{0.74}MoO₂, Li_{0.85}MoO₂ etc.

Reaction assumes C→CO reaction (i.e. >650° C.)

General Reaction

x/2Li₂CO₃+1.0MoO₃+3x/2C→LiₓMoO₂+3x/2CO+x/2CO₂

x/2 g-mol Li₂CO₃ is equivalent to (x/2 multiplied by 73.89) g

1.0 g-mol MoO₃ is equivalent to 143.94 g

3x/2 g-mol C is equivalent to (3x/2 multiplied by 12.00) g

An excess of carbon—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 4

### Carbothermal Reduction of MoO₃ to MoO₂ followed by Carbothermal Reduction of MoO₂ using Li₂CO₃ as the Lithium Source to Produce LiMoO₂

Step 1: Production of MoO₂

Reaction assumes C→CO reaction (i.e. >650° C.)

This reaction forms the first step of several other preparative examples.

Reaction

1.0MoO₃+1.0C→MoO₂+1.0CO

1.0 g-mol MoO₃ is equivalent to 143.94 g

1.0 g-mol C is equivalent to 12.00 g

An excess of carbon—typically 0-100% mass excess may be used.

Method

(a) Pre-mix powders in molar proportions as shown

(b) Pelletize powder mixture

(c) Heat the pellet at a rate of 1-5° C./minute to 650-950° C. in an inert atmosphere (N₂, Ar or vacuum)

(d) Dwell at desired temperature for 2-8 hours

(e) Cool to room temperature at a rate of 1-5° C./minute

(f) Remove from furnace when temperature of furnace <25° C.

(g) Transfer to bench top. MoO₂ is not air sensitive.

(h) Powderize

(i) Optionally, re-pelletize and repeat steps (c) through (h) above

Step 2: Production of LiMoO₂ using Li₂CO₃+MoO₂ produced in Step 1.

Reaction assumes C→CO reaction (i.e. >650° C.)

Reaction

0.5Li₂CO₃+1.0MoO₂+0.5C→LiMoO₂+0.5CO₂+0.5CO

0.5 g-mol Li₂CO₃ is equivalent to 36.95 g

1.0 g-mol MoO₂ is equivalent to 127.94 g

0.5 g-mol C is equivalent to 6.00 g

An excess of carbon—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 5

### Carbothermal Reduction of MoO₃ to MoO₂ followed by Carbothermal Reduction of MoO₂ using Li₂CO₃ as Lithium Source to Produce LiₓMoO₂

Step 1: Production of MoO₂

MoO₂ is prepared by carbothermal reduction of MoO₃ as in Step 1 of Example 4.

Step 2: Production of LiₓMoO₂ using Li₂CO₃

For example, Li_{0.74}MoO₂ and Li_{0.85}MoO₂ were synthesized by this method.

Reaction assumes C→CO reaction (i.e. >650° C.)

Reaction

x/2Li₂CO₃+1.0MoO₂+x/2C→LiₓMoO₂+x/2CO₂+x/2CO

x/2 g-mol Li₂CO₃ is equivalent to (x/2 multiplied by 73.89) g

1.0 g-mol MoO₂ is equivalent to 127.94 g

x/2 g-mol C is equivalent to (x/2 multiplied by 12.00) g

An excess of carbon—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above.

### Example 6

### Direct Carbothermal Reduction of MoO₃ using Li₂CO₃ as Lithium Source to Produce Li₄Mo₃O₈:

Reaction assumes C→CO reaction (i.e. >650° C.)

Reaction

2.0Li₂CO₃+3.0MoO₃+3.0C→Li₄Mo₃O₈+2.0CO₂+3.0CO

2.0 g-mol Li₂CO₃ is equivalent to 221.67 g

3.0 g-mol MoO₃ is equivalent to 431.82 g

3.0 g-mol C is equivalent to 36.00 g

An excess of carbon—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 7

### Carbothermal Reduction of MoO₃ to MoO₂ followed by Reaction of MoO₂ with Li₂CO₃ as Lithium Source to Produce Li₄Mo₃O₈:

Reaction assumes C→CO reaction (i.e. >650° C.)

Step 1: Production of MoO₂

Reaction

For reaction, see Step 1 of Example 4.

Step 2: Production of Li₄Mo₃O₈ using Li₂CO₃ and MoO₂ from Step 1.

Reaction

2.0Li₂CO₃+3.0MoO₂→Li₄Mo₃O₈+2.0CO₂

2.0 g-mol Li₂CO₃ is equivalent to 147.78 g

3.0 g-mol MoO₂ is equivalent to 383.82 g

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at a rate of 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 8

### Direct Reduction of Li₂MoO₄ using Mo Metal to Produce LiMoO₂:

Reaction

0.5Li₂MoO₄+0.5Mo→LiMoO₂

0.5 g-mol Li₂MoO₄ is equivalent to 86.91 g

0.5 g-mol Mo is equivalent to 47.97 g

An excess of Mo—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 9

### Reduction of MoO₃ to MoO₂ using Mo Metal followed by Reduction of MoO₂ using Mo Metal and Li₂CO₃ as Lithium Source to Produce LiₓMoO₂:

Step 1: Production of MoO₂

Reaction

0.667MoO₃+0.333Mo→MoO₂

0.667 g mol MoO₃ is equivalent to 95.96 g

0.333 g mol Mo metal is equivalent to 31.98 g

An excess of Mo—typically 0-100% mass excess may be used.

Method

(a) Pre-mix powders in molar proportions as shown

(b) Pelletize powder mixture

(c) Heat the pellet at a rate of 1-5° C./minute to 650-950° C. in an inert atmosphere (N₂, Ar or vacuum)

(d) Dwell at desired temperature for 2-8 hours

(e) Cool to room temperature at a rate of 1-5° C./minute

(f) Remove from furnace when temperature of furnace <25° C.

(g) Transfer to bench top. MoO₂ is not air sensitive.

(h) Powderize

(i) Optionally, re-pelletize and repeat steps (c) through (h) above

Step 2: Production of LiₓMoO₂ using Li₂CO₃

For example, Li_{0.74}MoO₂ and Li_{0.85}MoO₂may be synthesized by this method.

Additional Considerations:

Carbothermally produced MoO₂ (Example 4, Step 1) could also be used for Step 2.

Reaction

x/2Li₂CO₃+0.75MoO₂+0.25Mo→LiₓMoO₂+x/2CO₂

x/2 g-mol Li₂CO₃ is equivalent to (x/2 multiplied by 73.89) g

0.75 g-mol MoO₂ is equivalent to 95.96 g

0.25 g-mol Mo metal is equivalent to 23.99 g

An excess of Mo—typically 0-100% mass excess may be used.

Method

(a) Pre-mix powders in molar proportions as shown

(b) Pelletize powder mixture

(c) Heat pellet at rate of 1-5° C./minute to 650-950° C. in inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 10

### Reduction of MoO₃ to MoO₂ using Mo Metal followed by Reaction of MoO₂ with Li₂CO₃ as Lithium Source to Produce Li₄Mo₃O₈:

Step 1: Production of MoO₂

Reaction

0.667MoO₃+0.333Mo→MoO₂

0.667 g-mol MoO₃ is equivalent to 95.96 g

0.333 g-mol Mo metal is equivalent to 31.98 g

An excess of Mo—typically 0-100% mass excess may be used.

Method

(a) Pre-mix powders in molar proportions as shown

(b) Pelletize powder mixture

(c) Heat pellet at a rate of 1-5° C./minute to 650-950° C. in an inert atmosphere (N₂, Ar or vacuum)

(d) Dwell at desired temperature for 2-8 hours

(e) Cool to room temperature at a rate of 1-5° C./minute

(f) Remove from furnace when temperature of furnace <25° C.

(g) Transfer to bench top. MoO₂ is not air sensitive.

(h) Powderize

(i) Optionally, re-pelletize and repeat steps (c) through (h) above

Step 2: Production of Li₄Mo₃O₈ using Li₂CO₃ as lithium source and using MoO₂ produced in Step 1.

Carbothermally produced MoO₂ (Example 4, Step 1) may also be used for Step 2.

Reaction

2.0Li₂CO₃+3.0MoO₂→Li₄Mo₃O₈+2.0CO₂

2.0 g-mol Li₂CO₃ equivalent to 147.78 g

3.0 g-mol MoO₂ is equivalent to 383.82 g

Method

(a) Pre-mix powders in molar proportions as shown

(b) Pelletize powder mixture

(c) Heat the pellet at a rate of 1-5° C./minute to 650-950° C. in an inert atmosphere (N₂, Ar or vacuum)

(d) Dwell at desired temperature for 2-8 hours

(e) Cool to room temperature at rate 1-5° C./minute

(f) Remove from furnace when temperature of furnace <25° C.

(g) Transfer to inert atmosphere (e.g. Ar glove box). These materials are generally air sensitive.

(h) Powderize

(i) Optionally, re-pelletize and repeat steps (c) through (h) above

### Example 11

### Direct Reduction of Li₂MoO₄ using Mo Metal to Produce Li₄Mo₃O₈:

Reaction

2.0Li₂MoO₄+1.0Mo→Li₄Mo₃O₈

2.0 g-mol Li₂MoO₄ is equivalent to 347.64 g

1.0 g-mol Mo is equivalent to 95.94 g

An excess of Mo—typically 0-100% mass excess—may be used.

Method

(a) Pre-mix powders in molar proportions as shown.

(b) Pelletize the powder mixture.

(c) Heat the pellet at a rate of 1-5° C./minute to 650-950° C. in an inert atmosphere (N₂, Ar or vacuum).

(d) Dwell at desired temperature for 2-8 hours.

(e) Cool to room temperature at rate 1-5° C./minute.

(f) Remove from furnace when temperature of furnace <25° C.

(g) Transfer to an inert atmosphere (e.g. Ar glove box). These materials are generally air sensitive.

(h) Powderize.

(i) Optionally, re-pelletize and repeat steps (c) through (h) above.

Experimental—Electrochemical Measurements and Electrode Formulations

Electrochemical cells used for materials evaluation, were constructed in (i) lithium metal anode and (ii) lithium ion configurations. In lithium metal cells the active materials were cycled against a lithium metal counter electrode. In lithium ion configuration the active materials were cycled versus a suitably capacity balanced carbon electrode. In all lithium ion cells the active carbon used was MCMB-2528, which is a mesocarbon microbead (graphitic) material supplied by Alumina Trading, which is the U.S. distributor for the supplier, Osaka Gas Company of Japan.

The lithiated molybdenum oxides were used to formulate the positive electrode. The electrode was fabricated by solvent casting a slurry of the lithiated molybdenum oxides, conductive carbon, binder and solvent. The conductive carbon used was Super P (MMM Carbon). Kynar Flex 2801 was used as the binder and the electronic grade acetone was used as the solvent. The slurry was cast onto glass and a free-standing electrode film was formed as the solvent evaporated. The proportions are as follows on a weight basis: 80% active material; 8% Super P carbon; and 12% Kynar binder.

The MCMB-2528 carbon was used to formulate the negative electrode for the lithium ion test cells. The graphite carbon electrode was fabricated by solvent casting a slurry of MCMB-2528 graphite, conductive carbon, binder and casting solvent. The conductive carbon used was Super P (MMM Carbon). Kynar Flex 2801 was used as the binder and the electronic grade acetone was used as the solvent. The slurry was cast onto glass and a free-standing electrode film was formed as the solvent evaporated. The proportions are as follows on a weight basis: 85% active material; 3% Super P carbon; and 12% Kynar binder.

For all electrochemical cells the liquid electrolyte was ethylene carbonate/dimethyl carbonate, EC/DMC (2:1 by weight) and 1 M LiPF₆. This was used in conjunction with a glass fiber filter to form the anode-cathode separator.

Routine electrochemical testing was carried out with a commercial battery cycler utilizing constant current cycling between pre-set voltage limits. High-resolution electrochemical data was collected using the Electrochemical Voltage Spectroscopy (EVS) technique. Such technique is known in the art as described in Synth. Met. D217 (1989); Synth. Met. 32, 43 (1989); J. Power Sources, 52, 185 (1994); and Electrochimica Acta 40, 1603 (1995). Long term cycling of lithium metal cells was undertaken using a commercial Maccor Inc. Battery Cycler.

Experimental: Structural Measurements

A Siemens D500 x-ray diffractometer equipped with Cu K_{α} radiation (λ=1.54056 Å) was used for x-ray diffraction (XRD) studies of the as-made materials.

As a guide to the collected data for the LiMoO₂ system, we have calculated a XRD powder pattern, refined in the hexagonal system, space group R\overline{3}m (see Aleandri and McCarley, Inorg Chem., 27, 1041, 1988) using Cu K_{α} radiation. Selected peaks of the XRD pattern are given in Table 1.

TABLE 1
Calculated powder pattern (2-Theta between 10-50°)
for LiMoO₂ with hexagonal cell (R\overline{3}m) using Cu Kα
radiation (λ = 1.54056 Å).

| d-spacing, (Å) | hkl | 2-Theta, (°) |
|---|---|---|
| 5.937 | 003 | 16.565 |
| 2.922 | 006 | 33.963 |
| 2.742 | 101 | 36.257 |
| 2.647 | 012 | 37.600 |
| 2.336 | 104 | 42.778 |
| 2.165 | 015 | 46.323 |

Calculated Hexagonal unit cell: R\overline{3}m, a = b = 2.8902 Å, c = 15.7976 Å, cell volume = 114.2839 Å³.

Characterization of Active Materials

FIG. 1 shows the XRD data from the LiMoO₂ product made according to Example 1 from MoO₃/Li₂CO₃/carbon. 1.388 g of Li₂CO₃ (Pacific Lithium Company), 5.400 g of MoO₃ (Aldrich Chemical), and 1.013 g of Shawinighan Black Carbon (Chevron) were used. The reaction was carried out for 4 h at 850° C. under an argon atmosphere. The product compound appeared black in color and had good uniformity. The product included carbon that remained unreacted following the carbothermal reaction. The product was placed in an argon-filled glove box immediately following the preparative stage.

The x-ray diffraction pattern contained all the peaks expected for this material as described Table 1. However, other smaller unidentified peaks are also evident, demonstrating that this material has a low level of impurities present. It is likely that some level of partially-reduced Li—Mo—O compounds are also contained in the product.

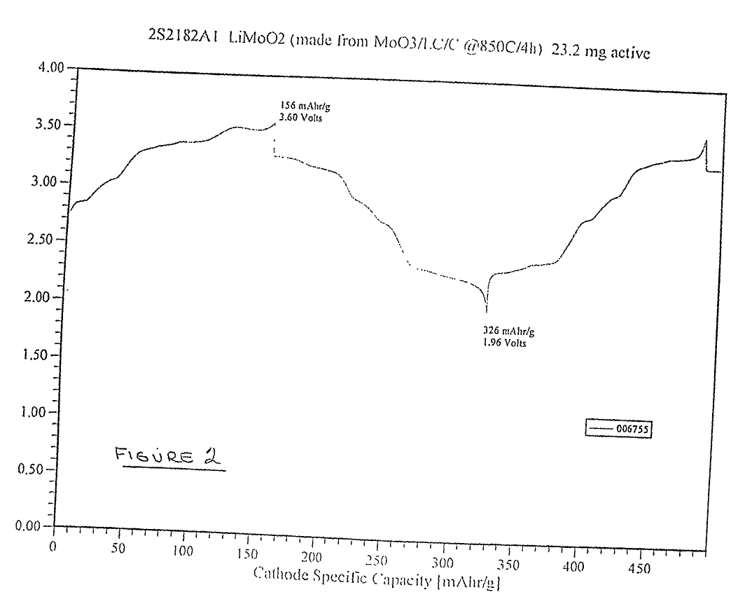

FIG. 2 (Cell#006755) shows the results of the first constant current cycling on the same material using a lithium metal counter electrode at 0.2 mA/cm² between 2.00 and 3.60 V based upon the 23.2 mg of the LiMoO₂ active material in the positive electrode. The testing was carried out at 23° C. The initial measured open circuit voltage (OCV) was approx. 2.70 V vs. Li. Lithium is extracted from the LiMoO₂ during charging of the cell. A charge equivalent to a material specific capacity of 156 mAh/g is extracted from the cell. The theoretical specific capacity for LiMoO₂ (assuming all the lithium is extracted) is 199 mAh/g. Consequently, the positive electrode active material corresponds to Li₁₋ₓMoO₂ where x equates to about 0.78, when the active material is charged to about 3.60 V vs. Li. When the cell is discharged to approx. 2.00 V a quantity of lithium is re-inserted into the Li₁₋ₓMoO₂. The re-insertion process corresponds to approximately 170 mAh/g, indicating that a greater amount of lithium than was extracted may be successfully re-inserted into the material. This demonstrates the excellent reversibility of the LiMoO2 material. At 2.00 V the positive active material corresponds to approximately Li_{1.07}MoO₂. The generally symmetric nature of the charge-discharge curves further indicates the good reversibility of the system.

Next, LiMoO₂ was made using LiOH as a lithium source according to Example 2. 1.678 g of LiOH.H₂O (Aldrich Chemical), 5.758 g of MoO₃ (Aldrich Chemical), and 1.440 g of Shawinighan Black Carbon (Chevron) were used. The reaction was carried out for 8 h at 850° C. under an argon atmosphere. The product compound appeared black in color and had excellent uniformity. The product included carbon that remained after the carbothermal reaction. The product was placed in an argon-filled glove box immediately following the preparative stage.

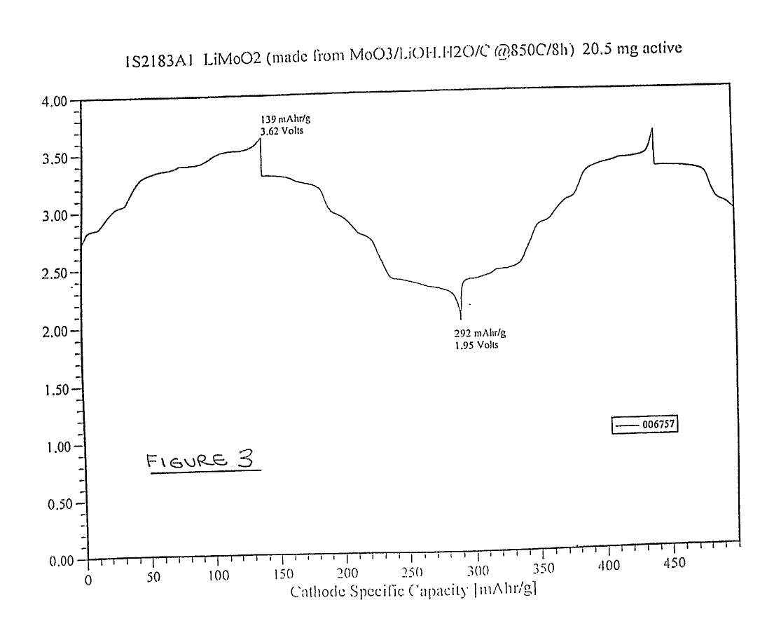

FIG. 3 (Cell#006757) shows the results of the first constant current cycling of the Example 2 material using a lithium metal counter electrode at 0.2 mA/cm² between 2.00 and 3.60 V based upon the 20.5 mg of the LiMoO₂ active material in the positive electrode. The testing was carried out at 23° C. The initial measured open circuit voltage (OCV) was approx. 2.70 V vs. Li. Lithium is extracted from the LiMoO₂ during charging of the cell. A charge equivalent to a material specific capacity of 139 mAh/g is extracted from the cell. The theoretical specific capacity for LiMoO₂ (assuming all the lithium is extracted) is 199 mAh/g. Consequently, the positive electrode active material corresponds to Li₁₋ₓMoO₂ where x equates to about 0.70, when the active material is charged to about 3.60 V vs. Li. When the cell is discharged to approx. 2.00 V a quantity of lithium is re-inserted into the Li₁₋ₓMoO₂. The re-insertion process corresponds to approximately 153 mAh/g, indicating that a greater amount of lithium than was extracted may be successfully re-inserted into the material. This demonstrates the excellent reversibility of the LiMoO₂ material. At 2.00 V the positive active material corresponds to approx. Li_{1.07}MoO₂. The generally symmetrical nature of the charge-discharge curves further indicates the good reversibility of the system.

A material having empirical formula Li_{0.74}MoO₂ was made according to Example 3. 0.270 g of Li₂CO₃ (Pacific Lithium Company), 1.440 g of MoO₃ (Aldrich Chemical), and 0.170 g of Shawinighan Black Carbon (Chevron) were used. The reaction was carried out for 600° C. for 1 h followed by 6 h at 850° C., both under an argon atmosphere. The product compound appeared black in color and had good uniformity. The product included carbon that remained after the carbothermal reaction. The product was placed in an argon-filled glove box immediately following the preparative stage.

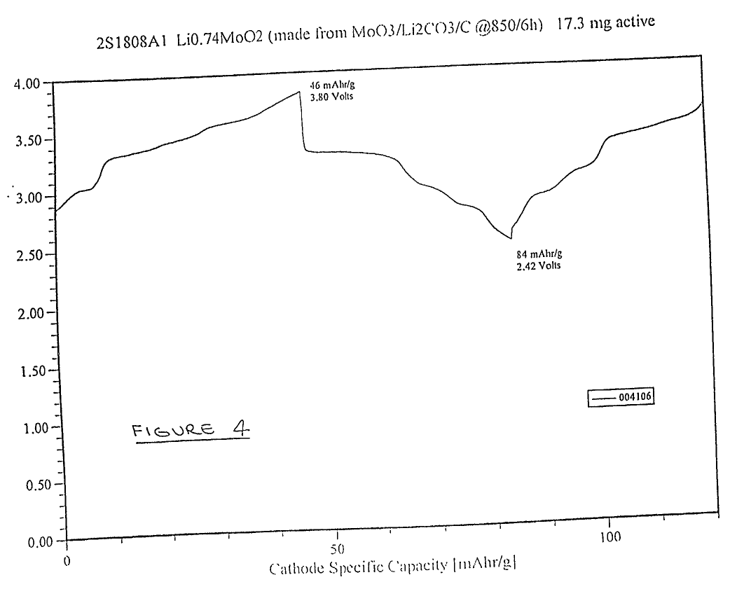

FIG. 4 (Cell#004106) shows the results of the first constant current cycling of the Example 3 material using a lithium metal counter electrode at 0.2 mnA/cm² between 2.40 and 3.80 V based upon the 17.3 mg of the Li_{0.74}MoO₂ active material in the positive electrode. The testing was carried out at 23° C. The initial measured open circuit voltage (OCV) was approx. 2.85 V vs. Li. Lithium is extracted from the Li_{0.74}MoO₂ during charging of the cell. A charge equivalent to a material specific capacity of 46 mAh/g is extracted from the cell. The theoretical specific capacity for Li_{0.74}MoO₂ (assuming all the lithium is extracted) is 149 mAh/g. Consequently, the positive electrode active material corresponds to Li_{0.74-x}MoO₂ where x equates to about 0.23 (i.e. to produce Li_{0.51}MoO₂), when the active material is charged to about 3.80 V vs. Li. When the cell is discharged to approx. 2.40 V a quantity of lithium is re-inserted into the Li_{0.51}MoO₂. The re-insertion process corresponds to approximately 38 mAh/g. This demonstrates the reversibility of the Li_{0.74}MoO₂ material. At 2.40 V the positive active material corresponds to approx. Li_{0.70}MoO₂. The generally symmetrical nature of the charge-discharge curves indicates the good reversibility of the system.

Example 4 to produce LiMoO₂ is carried out in two steps. The first step is a carbothermal reduction of MoO₃ to produce MoO₂, while step 2 involves carbothermal reduction and lithium incorporation to produce the LiMoO₂ product.

In Step 1, 21.585 g of MoO₃ (Aldrich Chemical) and 2.250 g of Shawinighan Black Carbon (Chevron) were used. This amount of carbon equates to a 25% weight excess over the amount calculated from a carbothermal reduction based solely on the C→CO reaction. The reaction was carried out for 4 h at 850° C. under an argon atmosphere. The product compound appeared dark brown in color and had good uniformity. The product included carbon that remained after the carbothermal reaction. The product was stored in laboratory ambient conditions following the preparative stage.

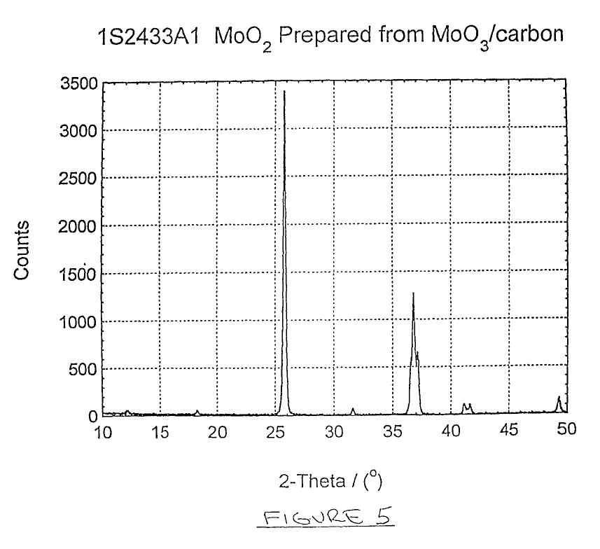

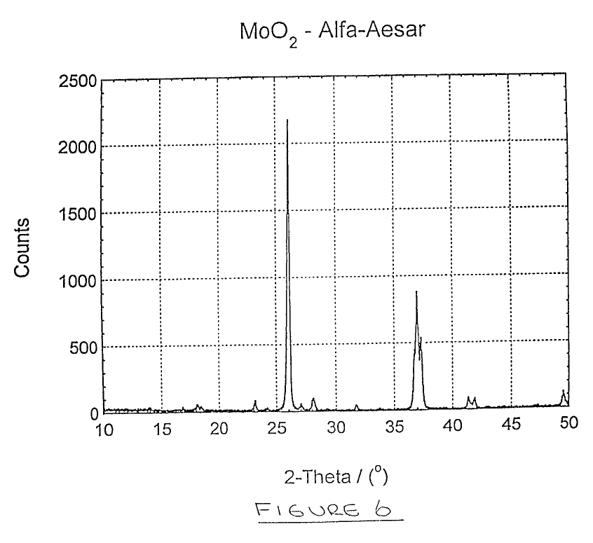

FIG. 5 shows the XRD data from the MoO₂ product prepared in Example 4, Step 1 MoO₃ and 25% excess carbon. Compare the x-ray diffraction pattern with that recorded from a commercial MoO₂ sample available from Alfa-Aesar, shown in FIG. 6. Clearly, all the peaks expected for this material are present in FIG. 5. The XRD data in FIG. 5 are consistent with a single phase, high purity product, with no peaks due to the presence of unreacted precursor.

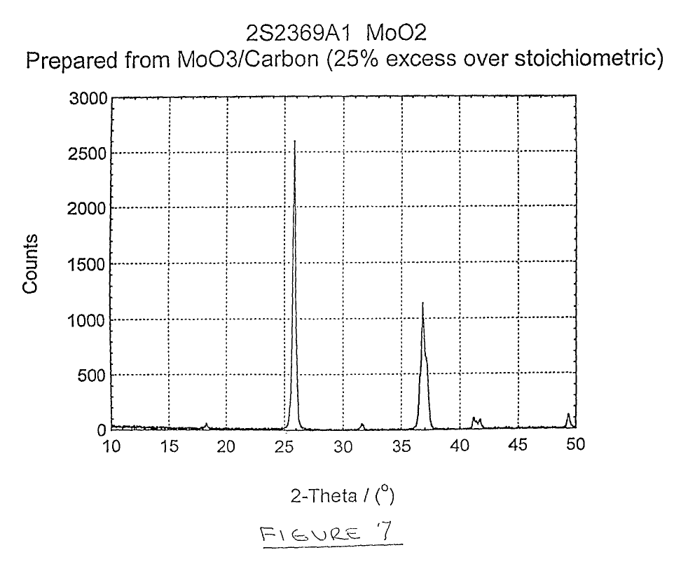

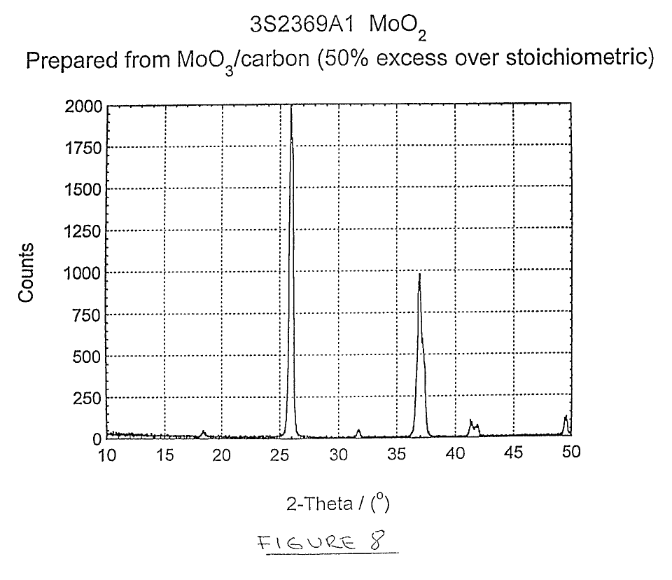

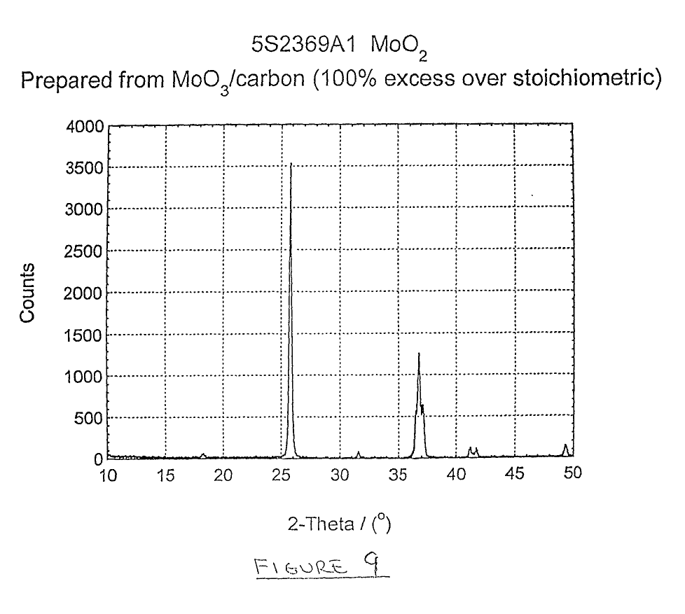

A second set of experiments was undertaken to look at the effect of carbon amount on the quality of the MoO₂. FIGS. 7, 8 and 9 show, respectively, the x-ray patterns collected for MoO₂ samples produced from the reaction between MoO₃ and carbon, where the amount of carbon is 25%, 50% and 100% over the amount required for a carbothermal reduction based on the C→CO reaction. The quality of the MoO₂ is high in all cases. All the data are consistent with single phase, high purity MoO₂, with no peaks due to the presence of unreacted precursor.

In Step 2 of Example 4, 0.560 g of Li₂CO₃ (Pacific Lithium Company), 1.920 g of MoO₂ (#2S2433A1), and 0.030 g of Shawinighan Black Carbon (Chevron) were used. The amount of carbon amounts to an approximate 25% weight excess over that calculated for a solely C→CO reaction. The reaction was carried out for 4 h at 850° C. under an argon atmosphere. The product compound appeared black in color and had good uniformity. The product included carbon that remained after the carbothermal reaction. The product was placed in an argon-filled glove box immediately following the preparative stage.

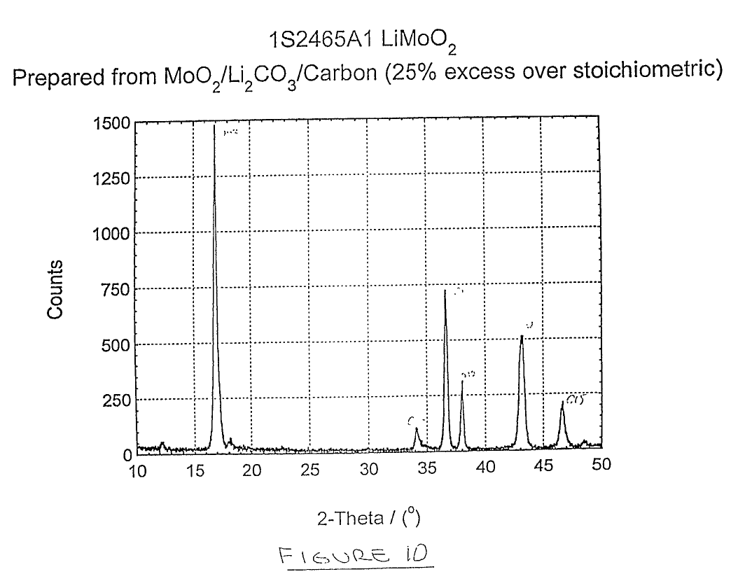

FIG. 10 shows the x-ray data from the LiMoO₂ from product made at 850° C. for 4 hours from MoO₂/Li₂CO₃/carbon (25% excess) in Example 4. The x-ray diffraction pattern contained all the peaks expected for this material as described in Table 1. The x-ray data in FIG. 10 are consistent with a single phase, high purity product, with no peaks due to the presence of unreacted precursors.

To investigate the effect of the amount of carbon in the reaction a separate experiment was carried out—using the same precursor MoO₂ (i.e. made in Step 1 of Example 4)—only this time using a 100% weight excess of carbon. 0.560 g of Li₂CO₃ (Pacific Lithium Company), 1.920 g of MoO₂, and 0.120 g of Shawinighan Black Carbon (Chevron) were used. The amount of carbon amounts to an approximate 100% weight excess over that calculated for a solely C→CO reaction. The reaction was carried out for 4 h at 850° C. under an argon atmosphere. The product compound appeared black in color and had good uniformity. The product included carbon that remained after the carbothermal reaction. The product was placed in an argon-filled glove box immediately following the preparative stage.

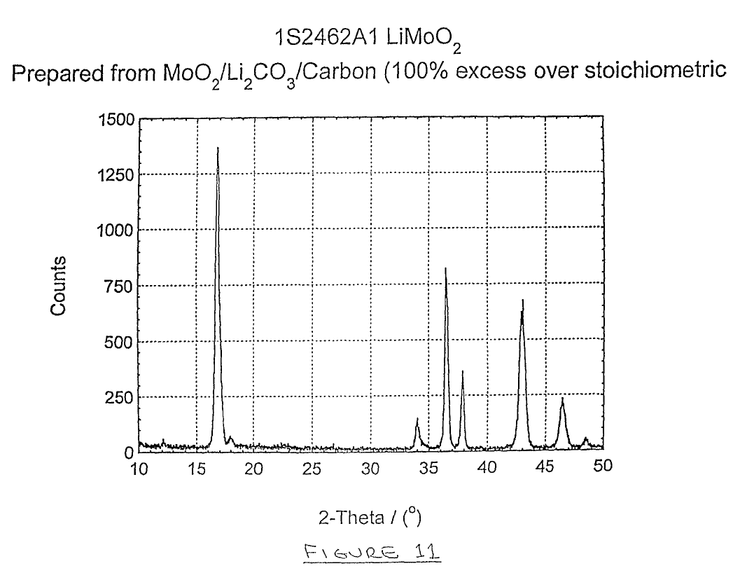

FIG. 11 shows the x-ray data from the LiMoO₂ product made at 850° C. for 4 hours from MoO₂/Li₂CO₃/carbon (100% excess). The x-ray diffraction pattern contained all the peaks expected for this material as described in Table 1 and is comparable to that shown in FIG. 10, the 25% excess carbon iteration. The x-ray data in FIG. 11 are consistent with a single phase, high purity product, with no peaks due to the presence of unreacted precursors.

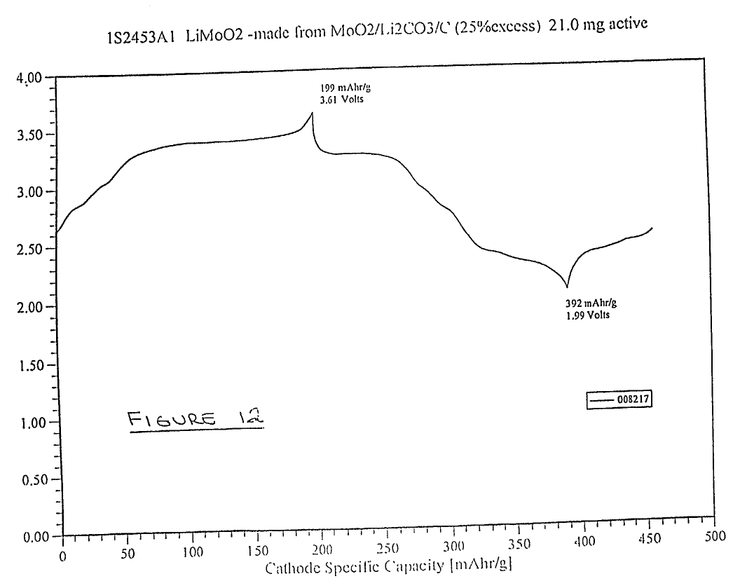

FIG. 12 (Cell#008217) shows the results of the first constant current cycling using a lithium metal counter electrode at 0.2 mA/cm² between 2.00 and 3.60 V based upon the 21.0 mg of the LiMoO₂ (made by Example 4 with 25% excess carbon in Step 2) active material in the positive electrode. The testing was carried out at 23° C. The initial measured open circuit voltage (OCV) was approx. 2.65 V vs. Li. Lithium is extracted from the LiMoO₂ during charging of the cell. A charge equivalent to a material specific capacity of 199 mAh/g is extracted from the cell. The theoretical specific capacity for LiMoO₂ (assuming all the lithium is extracted) is 199 mAh/g. Essentially all the available lithium is successfully extracted from the structure. Consequently, the positive electrode active material after charging corresponds to Li₁₋ₓMoO₂ where x equates to about 1.00, when the active material is charged to about 3.60 V vs. Li, indicating all the lithium has been removed from the compound. When the cell is discharged to approx. 2.00 V a quantity of lithium is re-inserted into the Li₁₋ₓMoO₂. The re-insertion process corresponds to approximately 193 mAh/g, indicating essentially all the lithium extracted during the charge process, could be re-inserted into the LiMoO₂ structure. This demonstrates the good reversibility of the LiMoO₂ material. At 2.00 V the positive active material corresponds to approx. Li_{0.97}MoO₂. The generally symmetrical nature of the charge-discharge curves further indicates the good reversibility of the system.

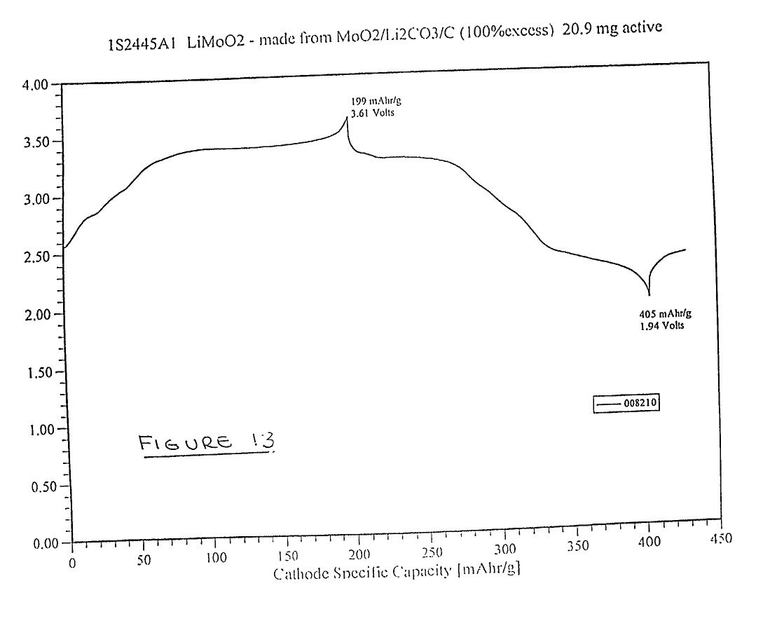

FIG. 13 (Cell#008210) shows the results of the first constant current cycling using a lithium metal counter electrode at 0.2 mA/cm² between 2.00 and 3.60 V based upon the 20.9 mg of the LiMoO₂ (made by Example 4 with 100% excess carbon in Step 2) active material in the positive electrode. The testing was carried out at 23° C. The initial measured open circuit voltage (OCV) was approx. 2.58 V vs. Li. Lithium is extracted from the LiMoO₂ during charging of the cell. A charge equivalent to a material specific capacity of 199 mAh/g is extracted from the cell. The theoretical specific capacity for LiMoO₂ (assuming all the lithium is extracted) is 199 mAh/g. Again, essentially all the available lithium is successfully extracted from the structure. Consequently, the positive electrode active material corresponds to Li₁₋ₓMoO₂ where x equates to about 1.00, when the active material is charged to about 3.60 V vs. Li, indicating all the lithium has been removed from the compound. When the cell is discharged to approx. 2.00 V a quantity of lithium is re-inserted into the Li₁₋ₓMoO₂. The re-insertion process corresponds to approximately 206 mAh/g, indicating that a greater amount of lithium than was extracted may be successfully re-inserted into the material. Essentially all the lithium extracted during the charge process could be re-inserted into the LiMoO₂ structure. This demonstrates the outstanding reversibility of the LiMoO₂ material. At 2.00 V the positive active material corresponds to approximately Li_{1.04}MoO₂. The generally symmetrical nature of the charge-discharge curves further indicates the good reversibility of the system.

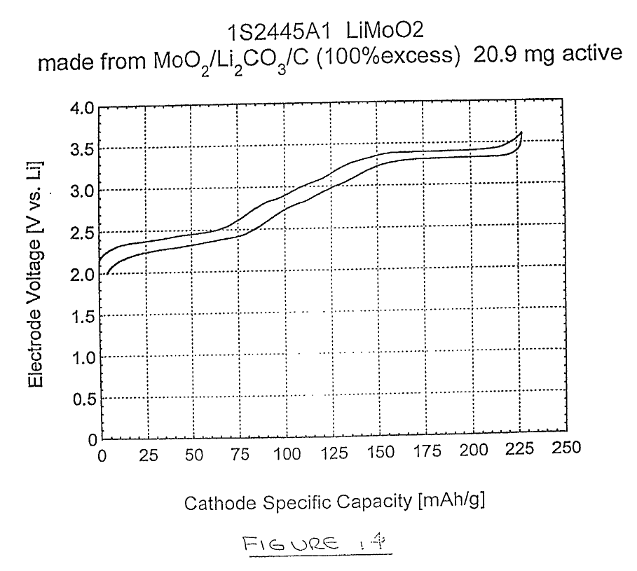

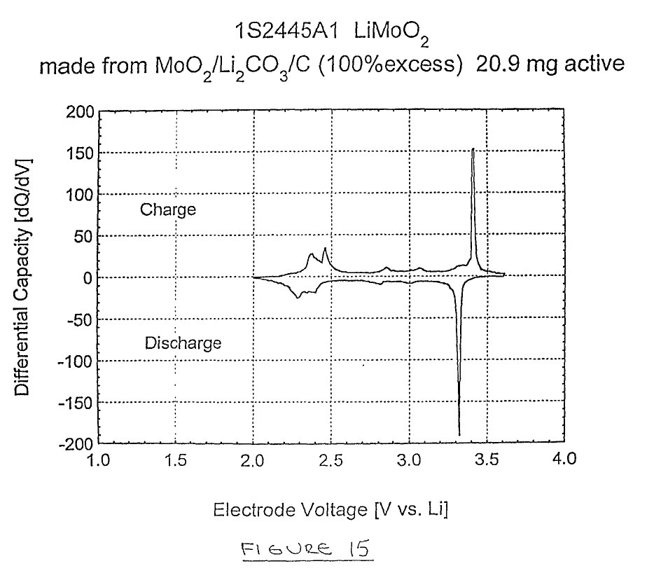

The LiMoO₂ material prepared in Example 4 with 100% excess carbon was subjected to further, high-resolution electrochemical testing using the Electrochemical Voltage Spectroscopy (EVS) technique. FIG. 14 shows results of this test using the method between pre-set voltage limits of 2.00 and 3.60 V. The weight of active positive material was 20.9 mg and the testing was carried out at 23° C. FIG. 14 demonstrates the excellent performance for the active material—a reversible specific capacity of approximately 225 mAh/g between the pre-set voltage limits as well as the good reversibility. The capacity corresponding to the lithium extraction process is essentially the same as the capacity corresponding to the subsequent lithium insertion process. Thus, there is essentially no capacity loss. FIG. 15, the differential capacity data of the same material, indicates excellent reversibility. The symmetrical nature of the peaks indicates good electrochemical reversibility; there are small peak separations (charge/discharge) and good correspondence between peaks above and below the zero axis. There are essentially no peaks that can be related to irreversible reactions, since all the peaks above the axis (cell charge) have corresponding peaks below the axis (cell discharge). This demonstrates that the preparative procedure used to make this material produces a high quality electrode material.

The MoO₂ made during the first step of Example 5 is produced under identical conditions to that described for the MoO₂ in Example 4, Step 1, above.

In Step 2 of Example 5, Li_{0.85}MoO₂ was produced. 0.940 g of Li₂CO₃ (Pacific Lithium Company), 3.840 g of MoO₂ (#2S2473A1), and 0.154 g of Shawinighan Black Carbon (Chevron) were used. The amount of carbon amounts to an approximate 100% weight excess over that calculated for a solely C→CO reaction. The reaction was carried out for 4 h at 850° C. under an argon atmosphere. The product compound appeared black in color and had good uniformity. The product included carbon that remained after the carbothermal reaction. The product was placed in an argon-filled glove box immediately following the preparative stage.

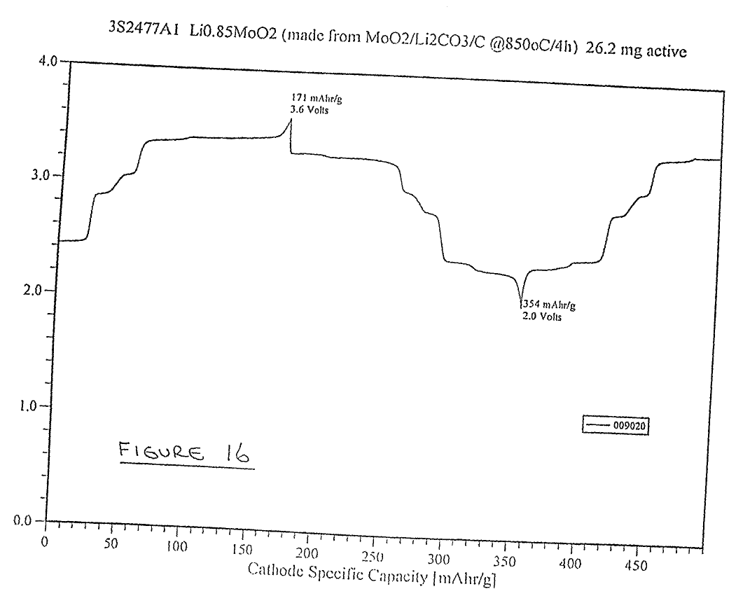

FIG. 16 (Cell#009020) shows the results of the first constant current cycling using a lithium metal counter electrode at 0.2 mA/cm² between 2.00 and 3.60 V based upon 26.2 mg of the Li_{0.85}MoO₂ active material made in Step 2 of Example 5 in the positive electrode. The testing was carried out at 23° C. The initial measured open circuit voltage (OCV) was approx. 2.42 V vs. Li. Lithium is extracted from the Li_{0.85}MoO₂ during charging of the cell. A charge equivalent to a material specific capacity of 171 mAh/g is extracted from the cell. The theoretical specific capacity for Li_{0.85}MoO₂ (assuming all the lithium is extracted) is 170 mAh/g. Essentially all the available lithium is successfully extracted from the structure. Consequently, the positive electrode active material corresponds to Li_{0.85-x}MoO₂ where x equates to about 0.85 (i.e. to produce Li_{0.00}MoO₂), when the active material is charged to about 3.60 V vs. Li. When the cell is discharged to approx. 2.00 V a quantity of lithium is re-inserted into the Li_{0.00}MoO₂. The re-insertion process corresponds to approximately 183 mAh/g indicating that a greater amount of lithium than was extracted may be successfully re-inserted into the material. This demonstrates the reversibility of the Li_{0.85}MoO₂ material. At 2.00 V the positive active material corresponds to approx. Li_{0.92}MoO₂. The generally symmetrical nature of the charge-discharge curves indicates the good reversibility of the system. Note from FIG. 16, the distinct voltage plateaux present—clearly indicating the structural changes occurring within the material during the various cell charge-discharge (lithium extraction-insertion) processes. Also note the excellent correspondence of these voltage plateaux from cell charge to cell discharge. These structural changes are reversible.

In a similar manner to the preparation of Li_{0.85}MoO₂ we will now show representative data for the Li_{0.74}MoO₂ material made by Example 5. The MoO₂ made during the first step of Preparative Example 5 is produced under identical conditions to that described for the MoO₂ in Preparative Example 4, Step 1, above.

In Step 2 of Example 5, Li_{0.74}MoO₂ is produced. 0.810 g of Li₂CO₃ (Pacific Lithium Company), 3.840 g of MoO₂ (#2S2473A1), and 0.132 g of Shawinighan Black Carbon (Chevron) were used. The amount of carbon amounts to an approximate 100% weight excess over that calculated for a solely C→CO reaction. The reaction was carried out for 4 h at 800° C. under an argon atmosphere. The product compound appeared black in color and had good uniformity. The product included carbon that remained after the carbothermal reaction. The product was placed in an argon-filled glove box immediately following the preparative stage.

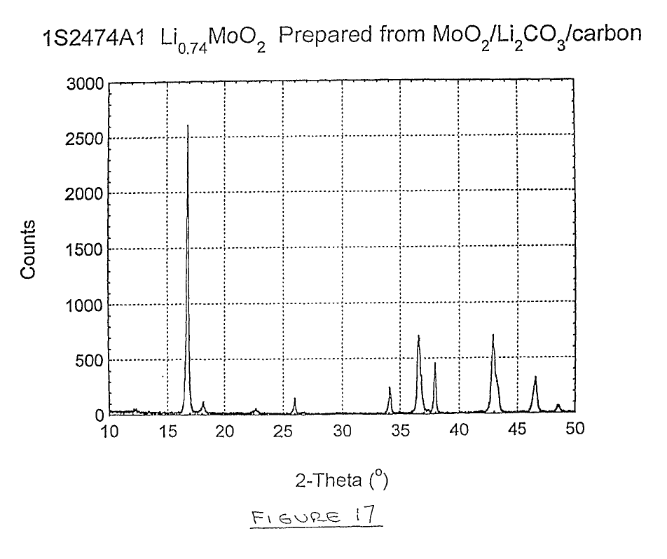

FIG. 17 shows the x-ray data from the Li_{0.74}MoO₂ product of Example 5 made at 800° C. for 4 hours from MoO₂/Li₂CO₃/carbon (100% excess). The x-ray diffraction pattern contains all the expected peaks and is comparable to that shown for high quality LiMoO₂ in FIG. 10, the 25% excess carbon iteration. The Li_{0.74}MoO₂ material is structurally similar to LiMoO₂ and may be alternatively described as Li_{0.74}V_{0.26}MoO₂ where V represents a vacant octahedral metal site. The x-ray data in FIG. 17 are consistent with the presence of a single phase, high purity product, with a presence of a small amount of unreacted MoO₂.

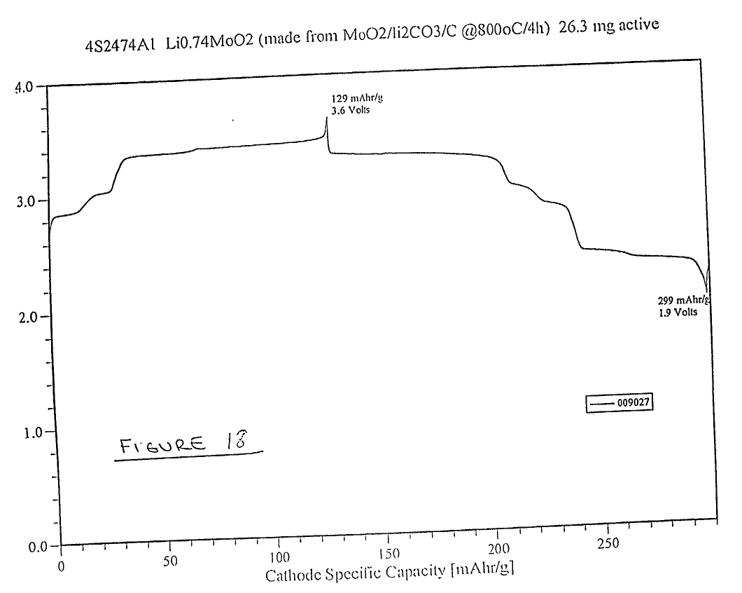

FIG. 18 (Cell#009027) shows the results of the first constant current cycling using a lithium metal counter electrode at 0.2 mA/cm² between 2.00 and 3.60 V based upon 26.3 mg of the Li_{0.74}MoO₂ active material in the positive electrode. The testing was carried out at 23° C. The initial measured open circuit voltage (OCV) was approx. 2.70 V vs. Li. Lithium is extracted from the Li_{0.74}MoO₂ during charging of the cell. A charge equivalent to a material specific capacity of 129 mAh/g is extracted from the cell. The theoretical specific capacity for Li_{0.74}MoO₂ (assuming all the lithium is extracted) is 149 mAh/g. Consequently, the positive electrode active material corresponds to Li_{0.74-xMoO}₂ where x equates to about 0.64 (i.e. to produce Li_{0.10}MoO₂), when the active material is charged to about 3.60 V vs. Li. When the cell is discharged to approx. 2.00 V a quantity of lithium is re-inserted into the Li_{0.10}MoO₂. The re-insertion process corresponds to approximately 170 mAh/g indicating that a greater amount of lithium than was extracted, may be successfully re-inserted into the material. This demonstrates the reversibility of the Li_{0.74}MoO₂ material. At 2.00 V the positive active material corresponds to approximately Li_{0.94}MoO₂. The generally symmetrical nature of the charge-discharge curves indicates the good reversibility of the system. Note from FIG. 18, in a similar fashion to that noted for Li_{0.85}MoO₂, the distinct voltage plateaux present. This indicates structural changes occurring within the material during the various cell charge-discharge (lithium extraction-insertion) processes. Also note the correspondence of these voltage plateaux from cell charge to cell discharge. The structural changes are reversible.

The MoO₂ made during the first step of Preparative Example 7 is produced under identical conditions to that described for the MoO₂ in Preparative Example 4, Step 1, above.

In Step 2 of Example 7, Li₄Mo₃O₈ is produced by reacting 0.437 g of Li₂CO₃ (Pacific Lithium Company) and 1.136 g of MoO₂ made in the first step. No additional carbon was added since no reduction of Mo is required to make Li₄Mo₃O₀₈ from MoO₂ (both contain Mo in oxidation state +4). This is a lithium incorporation reaction. The reaction was carried out for 4 h at 850° C. under an argon atmosphere. The product compound appeared black in color and had good uniformity. The product was placed in an argon-filled glove box immediately following the preparative stage.

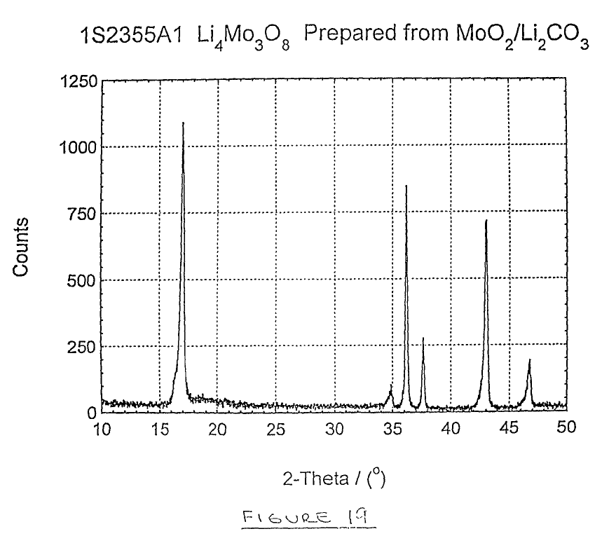

FIG. 19 shows the x-ray data from the Li₄Mo₃O₈ product made at 750° C. for 4 hours from MoO₂ and Li₂CO₃ in Example 7. The x-ray diffraction pattern for Li₄Mo₃O₈ has similar characteristics to that for the structurally similar compound LiMoO₂ (they are both layered) as reported by Hibble and Fawcett, Inorg. Chem 34, 500 (1995). In fact, Hibble et al. describe the formula of Li₄Mo₃O₈ as better characterized as either Li[Mo_{¾}V_{¼}]O₂ or Li_{¾}V_{¼}[Mo_{¾}Li_{¼}]O₂, where V is a vacant octahedral metal site, indicating its relationship with LiMoO₂ (see Hibble et al. Acta Cryst. B53, 604, 1997)). The x-ray diffraction pattern for the Li₄Mo₃O₈ (see FIG. 19) contained all the peaks described in Table 1, and few if any peaks due to the presence of unreacted precursors. It is comparable to that shown in FIG. 15 for high quality LiMoO₂. The x-ray data in FIG. 19 are consistent with a single phase, high purity product.

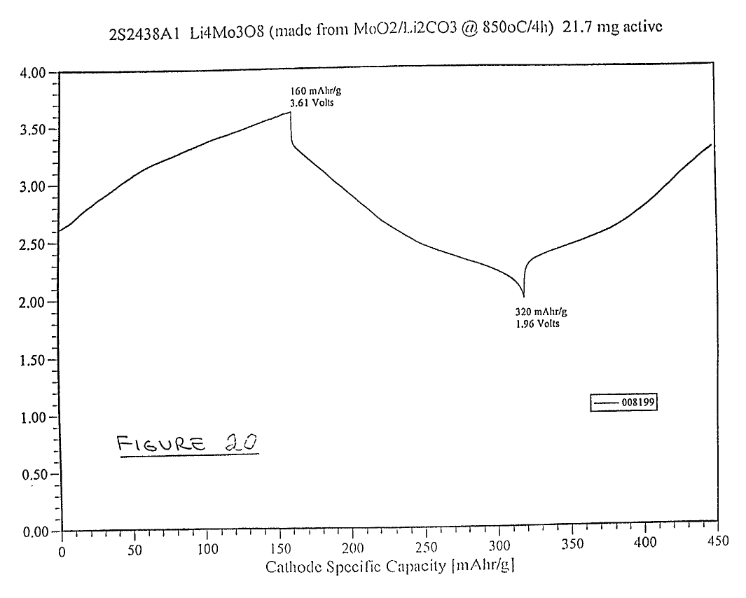

FIG. 20 (Cell#008199) shows the results of the first constant current cycling using a lithium metal counter electrode at 0.2 mA/cm2 between 2.00 and 3.60 V based upon the 21.7 mg of the Li4Mo3O8 active material made in Example 7 in the positive electrode. The testing was carried out at 23° C. The initial measured open circuit voltage (OCV) was approx. 2.62 V vs. Li. Lithium is extracted from the Li4Mo3O8 during charging of the cell. A charge equivalent to a material specific capacity of 160 mAh/g is extracted from the cell. The theoretical specific capacity for Li4Mo3O8 (assuming all the lithium is extracted) is 242 mAh/g. Consequently, the positive electrode active material corresponds to Li4−xMo3O8 where x equates to about 2.64 (i.e. to produce Li1.36Mo3O8), when the active material is charged to about 3.60 V vs. Li. When the cell is discharged to approx. 2.00 V a quantity of lithium is re-inserted into the Li1.36Mo3O8. The re-insertion process corresponds to approximately 160 mAh/g indicating the reversibility of the Li4Mo3O8 material. At 2.00 V the positive active material corresponds to approximately Li4.00Mo3O8. The generally symmetrical nature of the charge-discharge curves indicates the good reversibility of the system. Note from FIG. 20, the lack of voltage structure in the cell charge-discharge behavior. This is different from the voltage response for Li0.74MoO2 and Li0.85MoO2, where distinct voltage plateaus were present. This indicates a lack of structural changes occurring in this material during the lithium extraction-insertion processes.

A LiMoO₂ product was made from Li₂MoO₄ and Mo metal in Example 8. 3.220 g of Li₂MoO₄ (Alfa-Aesar), and 1.780 g of Mo metal (Alfa-Aesar) were used. This corresponds to a stoichiometric mix with no excess of either precursor. The reaction was carried out for 2 h at 950° C. under an argon atmosphere. The product compound appeared black in color and had excellent uniformity. The product was placed in an argon-filled glove box immediately following the preparative stage.

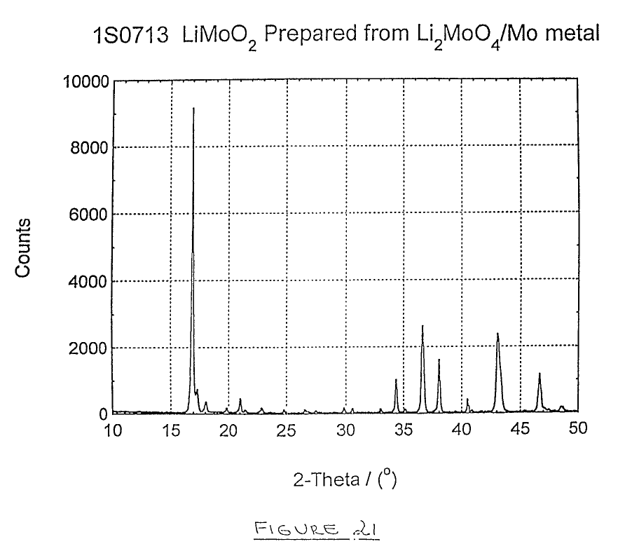

FIG. 21 shows the x-ray diffraction data from the LiMoO₂ product made at 950° C. for 2 hours from Li₂MoO₄ and Mo metal. The x-ray diffraction pattern contained all the expected peaks for this material as described in Table 1 and is comparable to that shown in FIG. 15, the 25% excess carbon carbothermal LiMoO₂ iteration. The x-ray data in FIG. 21 are consistent with the presence of a single phase, high purity product, together with a small amount of unidentified impurities.

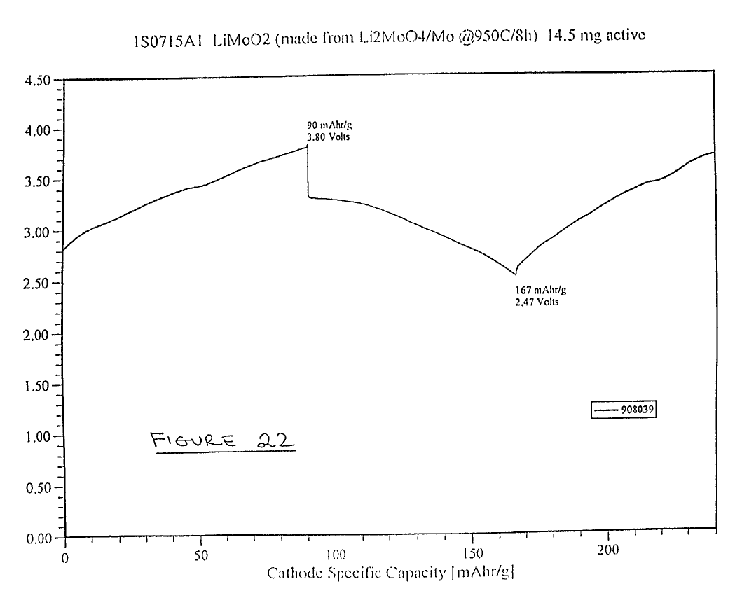

FIG. 22 (Cell#908039) shows the results of the first constant current cycling using a lithium metal counter electrode at 0.2 mA/cm² between 2.50 and 3.80 V based upon the 14.5 mg of the LiMoO₂ active material of Example 8 in the positive electrode. The testing was carried out at 23° C. The initial measured open circuit voltage (OCV) was approx. 2.85 V vs. Li. Lithium is extracted from the LiMoO₂ during charging of the cell. A charge equivalent to a material specific capacity of 90 mAh/g is extracted from the cell. The theoretical specific capacity for LiMoO₂ (assuming all the lithium is extracted) is 199 mAh/g. Consequently, the positive electrode active material corresponds to Li₁₋ₓMoO₂ where x equates to about 0.45, when the active material is charged to about 3.80 V vs. Li. When the cell is discharged to approx. 2.50 V a quantity of lithium is re-inserted into the Li₁₋ₓMoO₂. The re-insertion process corresponds to approximately 77 mAh/g. This demonstrates the reversibility of this LiMoO₂ material. At 2.50 V the positive active material corresponds to approximately Li_{0.94}MoO₂. The generally symmetrical nature of the charge-discharge curves further indicates the reversibility of the system.

In Example 11, Li₄Mo₃O₈ was prepared from 7.840 g of Li₂MoO₄ (Alfa-Aesar) and 2.700 g of Mo metal (Alfa-Aesar). This corresponds to a 25% weight excess of Mo over the stoichiometric reaction. The reaction was carried out first at 700° C. for 4 h, and second at 750° C. for 4 h, both under an argon atmosphere. The product compound appeared black in color and had excellent uniformity. Based on the excess Mo used, this product probably also contained a low level of the metal as an impurity. The product was placed in an argon-filled glove box immediately following the preparative stage.

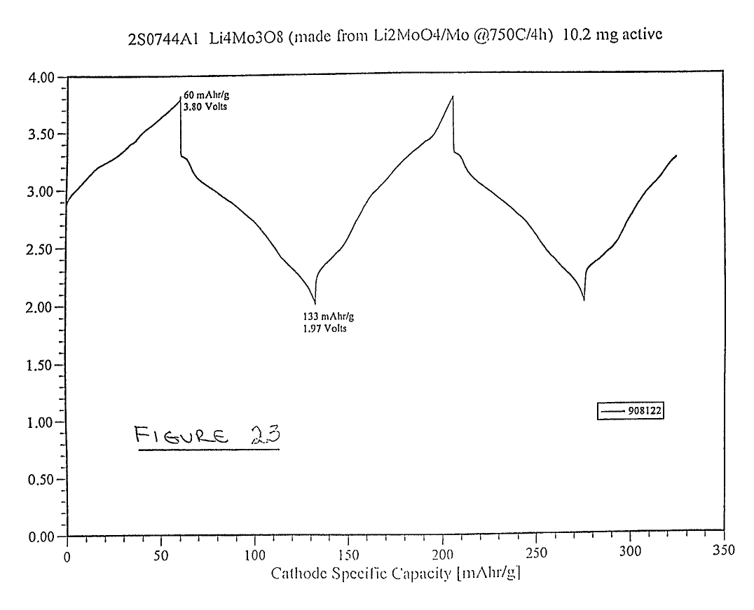

FIG. 23 (Cell#908122) shows the results of the first constant current cycling using a lithium metal counter electrode at 0.2 mA/cm² between 2.00 and 3.80 V based upon the 10.2 mg of the Li₄Mo₃O₈ active material in the positive electrode. The testing was carried out at 23° C. The initial measured open circuit voltage (OCV) was approx. 2.88 V vs. Li. Lithium is extracted from the Li₄Mo₃O₈ during charging of the cell. A charge equivalent to a material specific capacity of 60 mAh/g is extracted from the cell. The theoretical specific capacity for Li₄Mo₃O₈ (assuming all the lithium is extracted) is 242 mAh/g. Consequently, the positive electrode active material corresponds to Li₄₋ₓMo₃O₈ where x equates to about 1.00, when the active material is charged to about 3.80 V vs. Li. When the cell is discharged to approx. 2.00 V a quantity of lithium is re-inserted into the Li₄₋ₓMo₃O₈. The re-insertion process corresponds to approximately 73 mAh/g. This demonstrates the reversibility of this Li₄MoO₈ material. At 2.00 V the positive active material corresponds to approximately Li_{4.24}MoO₂. The generally symmetrical nature of the charge-discharge curves further indicates the reversibility of the system.

Long Term Cycling

Longer term cycling in lithium metal cells of some of the lithium molybdenum oxide iterations was undertaken on a commercial Maccor Inc. Battery Cycler. The constant current cycling of the cells was carried out between preset voltage limits of 2.00 and 3.60 V at 23° C. The current density for cell charge and discharge was set, such that a single discharge reaction (lithium insertion) took approximately 12 hours to complete i.e. a C/12 rate.

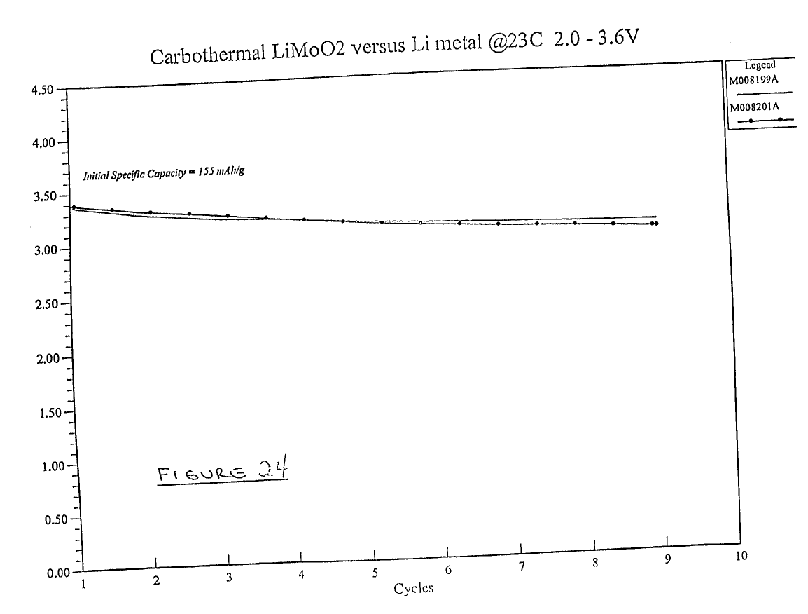

FIG. 24 depicts the cycling behavior of two lithium cells using a single carbothermally prepared LiMoO₂ iteration (Example 4) as the positive active material. Based on the weight of cathode material used, the initial cathode specific capacity in each cell may be estimated at about 155 mAh/g. Over the 9 cycles shown the cells show good capacity retention with only a small loss of capacity.

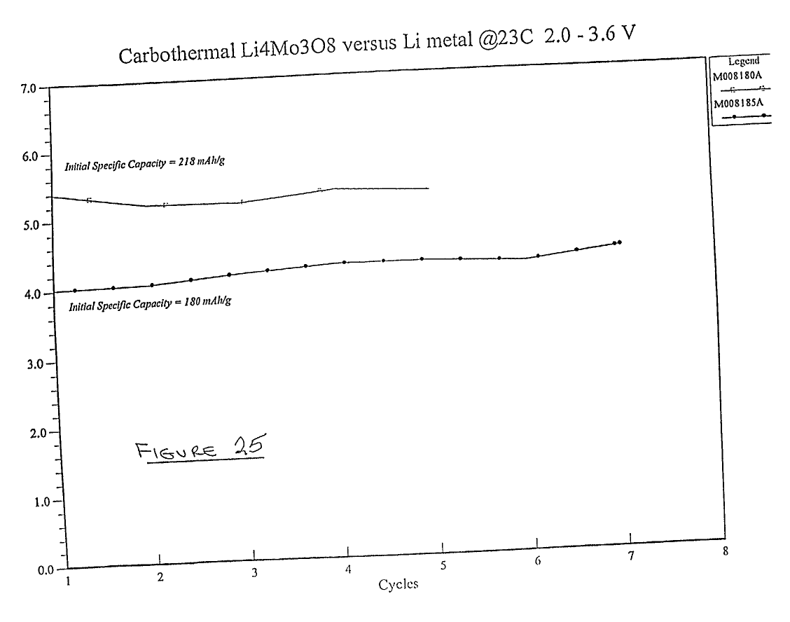

The cycling performance of the carbothermally prepared Li₄Mo₃O₈ (Example 7) is shown in FIG. 25. Two lithium cells are shown. In the first cell (Cell#M008180A) the initial specific capacity was 218 mAh/g, and in the second 180 mAh/g. Over the limited number of cycles shown, each of the cells shows good capacity retention.

Lithium Ion Testing

Lithium ion cells comprise an anode, cathode and an electrolyte. The cells were constructed using either a LiMoO₂ (Preparative Example 4) or a Li₄Mo₃O₈ (Preparative Example 7) cathode active material. In lithium ion configuration the active materials were cycled versus a suitably capacity balanced MCMB-2528 anode electrode. The cells were tested using the Electrochemical Voltage Spectroscopy (EVS) technique.

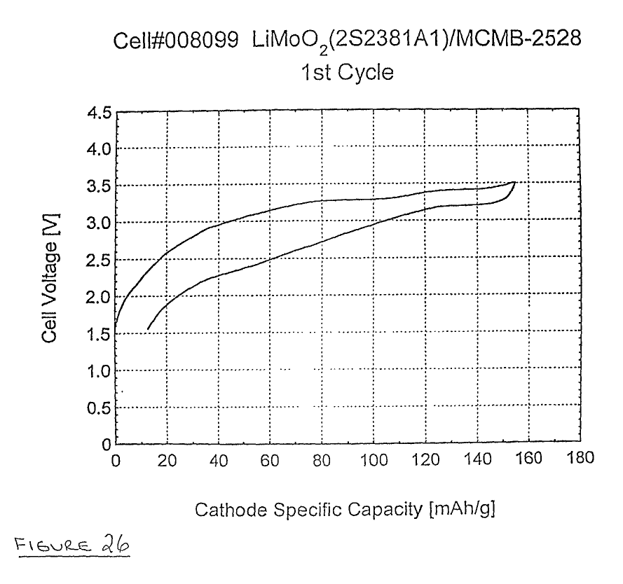

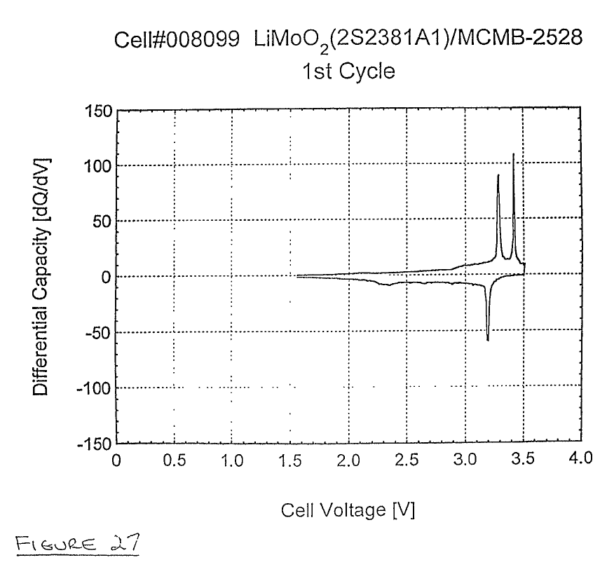

FIG. 26 shows the first cycle EVS voltage-capacity response for a LiMoO₂-MCMB-2528 lithium ion cell. The cell (cell#008099) comprised 21.9 mg active LiMoO₂ and 10.5 mg active MCMB-2528 for a cathode to anode mass ratio of 2.09: 1. The cell was charged and discharged at 23° C. at an approximate C/10 (10 hour) rate between voltage limits of 1.50 V and 3.50 V. FIG. 26 shows the variation in cell voltage versus cathode specific capacity for the LiMoO₂-MCMB-2528 lithium ion cell. The cathode active material shows a reversible specific capacity of over 140 mAh/g, and the first cycle capacity loss is less than 9%. The MCMB2528 reversibly cycles at approximately 293 mAh/g. FIG. 27 shows the corresponding EVS differential capacity data for the LiMoO₂-MCMB-2528 lithium ion cell and demonstrate the reversibility of the system.

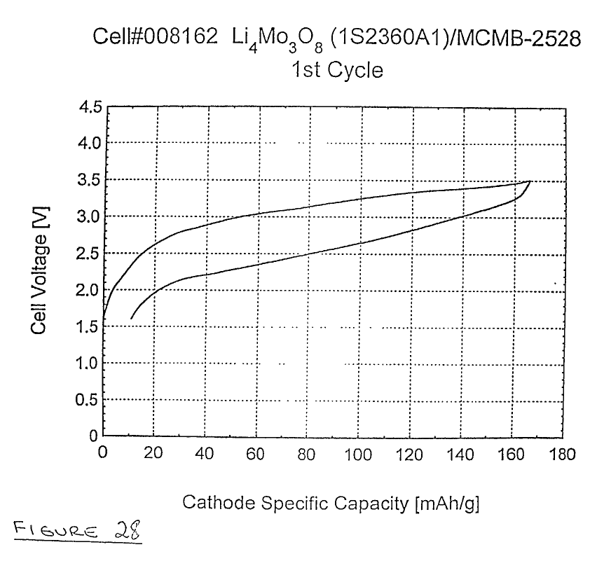

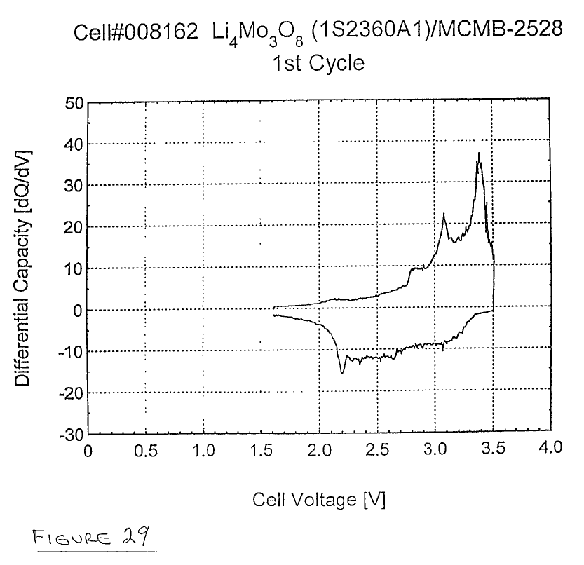

The first cycle EVS data for a Li₄Mo₃O₈-MCMB-2528 lithium ion cell are shown in FIGS. 28 and 29. The cell (cell#008162) comprised 18.9 mg active Li₄Mo₃O₈ and 10.6 mg active MCMB-2528 for a cathode to anode mass ratio of 1.78 1. The cell was charged and discharged at 23° C. at an approximate C/10 (10 hour) rate between voltage limits of 1.55 V and 3.50 V. FIG. 28 shows the variation in cell voltage versus cathode specific capacity for the Li₄Mo₃O₈-MCMB-2528 lithium ion cell. The cathode active material shows a reversible specific capacity of over 155 mAh/g, and the first cycle capacity loss is less than 7%. The MCMB2528 reversibly cycles at approximately 276 mAh/g. In common with the LiMoO₂-MCMB-2528 lithium ion cell, this is very good electrochemical performance. The differential capacity profile shown in FIG. 29 illustrates the reversibility of the system.

We claim:

1. A process for synthesis of lithiated molybdenum oxides comprising the step of reacting together
a lithium source and
a source of molybdenum comprising molybdenum in an initial oxidation state in the presence of
reducing carbon,
wherein the oxidation state of molybdenum in the product is lower than the initial oxidation state.

2. A process according to claim 1, wherein the reacting step comprises
providing as starting materials the lithium source, molybdenum source, and carbon in powder form;
mixing the starting materials together; and
heating the mixed starting materials at a temperature sufficient to form a reaction product.

3. A process according to claim 1, wherein the reducing carbon comprises elemental carbon.

4. A process according to claim 1, wherein the reducing carbon is generated in situ by decomposition of an organic material.

5. A process according to claim 2, wherein the heating step is carried out in an essentially non-oxidizing atmosphere.

6. A process according to claim 1, wherein the lithium source is selected from the group consisting of lithium carbonate, lithium phosphate, lithium oxide, lithium hydroxide, lithium vanadate, lithium acetate, lithium oxalate, lithium nitrate, hydrates thereof, and combinations thereof.

7. A process according to claim 1, wherein the lithium source comprises lithium carbonate.

8. A process according to claim 1, wherein the molybdenum source comprises an oxide selected from the group consisting of molybdenum trioxide, molybdenum dioxide, and combinations thereof.

9. A process according to claim 3, wherein elemental carbon is present in stoichiometric excess.

10. A process according to claim 1, wherein during the reaction, carbon is oxidized to carbon monoxide.

11. A process according to claim 1, wherein during the reaction, carbon is oxidized to carbon dioxide.

12. A process according to claim 1, wherein molybdenum in the reaction product has an oxidation state of from +3 to +4.

13. A process according to claim 1, wherein molybdenum in the reaction product has an oxidation state of from +3 to +3.5.

14. A process according to claim 1, wherein the molybdenum source comprises the product of reaction of a molybdenum compound and elemental carbon.

15. A process according to claim 14, wherein the molybdenum compound comprises molybdenum trioxide and the molybdenum source comprises molybdenum dioxide.

16. A process for preparation of compounds having general formula
LiₓMoO₂
where x is greater than 0 and less than or equal to 2, and molybdenum has an average oxidation state of +(4−x), comprising the steps of
providing starting materials in powdered form, the starting materials comprising
a lithium source;
a molybdenum source in an amount such that the molar ratio of molybdenum to lithium in the starting materials is 1 to x; and
reducing carbon in a molar amount at least sufficient to reduce molybdenum to its final oxidation state;
mixing the starting material powders; and
heating the mixed starting materials at a temperature sufficient to form a reaction product.

17. A process according to claim 16, wherein the reducing carbon comprises elemental carbon.

18. A method according to claim 17, wherein carbon is present in stoichiometric excess.

19. A method according to claim 16, wherein the molybdenum source comprises MoO₂ prepared by carbothermal reduction of MoO₃.

20. A method according to claim 16, wherein x is from 0.5 to 1.2.

21. A process for preparation of compounds of general formula
Li₄Mo₃O₈
comprising the steps of
providing starting materials in powdered form, the starting materials comprising
a lithium source;
a molybdenum source; and
reducing carbon in a stoichiometric amount at least sufficient to reduce molybdenum to its final oxidation state, wherein the molar ratio of molybdenum to lithium in the starting materials is about 3 to 4;
mixing the starting material powders together;
optionally pelletizing the mixed starting materials; and
heating the mixed starting materials at a temperature sufficient to form a reaction product.

22. A process according to claim 21, wherein the reducing carbon comprises elemental carbon.

23. A process according to claim 22, wherein the carbon is present in stoichiometric excess.

24. A process according to claim 21, wherein the heating step is carried out in an essentially non-oxidizing atmosphere.

25. A process according to claim 21, wherein the molybdenum source comprises MoO₂ prepared by carbothermal reduction of MoO₃.

26. A process for preparing lithiated molybdenum oxides comprising
reacting in a first step MoO₃ with elemental carbon to produce MoO₂; and
reacting in a second step, the MoO₂ from the first step with a lithium source to produce the lithiated molybdenum oxide.

27. A process according to claim 26, wherein the lithium source is selected from the group consisting of lithium carbonate, lithium phosphate, lithium oxide, lithium hydroxide, lithium vanadate, lithium acetate, lithium oxalate, lithium nitrate, hydrates thereof, and combinations thereof.

28. A process according to claim 26, wherein the lithium source comprises lithium carbonate.

29. A process according to claim 26, wherein the reaction of the second step is carried out in the presence of an amount of reducing carbon sufficient to reduce molybdenum in the reaction.

30. A process according to claim 29, wherein carbon is present in stoichiometric excess.

31. A process according to claim 26, wherein molybdenum is not reduced during the second step.

32. A process according to claim 26, wherein the lithiated molybdenum oxide is represented by the general formula
LiₓMoO₂
where x is from 0.01 to 2.

33. A process according to claim 26, wherein the lithiated molybdenum oxide product is represented by the general formula
Li₄Mo₃O₈.

34. A battery comprising a negative electrode and a positive electrode, wherein the positive electrode comprises an active material made by the process of claim 1.

35. A method for reducing a molybdenum compound, comprising the step of reacting together reducing carbon and a molybdenum compound having molybdenum in an initial oxidation state to produce a reaction product having molybdenum in a final oxidation state, wherein the final oxidation state is lower than the initial oxidation state.

36. A method according to claim 35, wherein the reducing carbon comprises elemental carbon

37. A method according to claim 35, wherein the initial oxidation state is +6.

38. A method according to claim 35, wherein the final oxidation state is +4.

39. A method according to claim 35, wherein the starting material is molybdenum trioxide.

40. A method according to claim 35, wherein the reaction product has an oxidation state of +2 or greater.

41. A method according to claim 36, wherein elemental carbon is present in stoichiometric excess.

42. A process for synthesizing lithiated molybdenum oxide, comprising the step of reacting together
a lithium source and
a molybdenum source having molybdenum in an initial oxidation state in the presence of
elemental molybdenum,
wherein the molybdenum of the molybdenum source is reduced to a final oxidation state lower than the initial oxidation state during the reaction.

43. A method according to claim 42, wherein the reacting step comprises
providing as starting materials the lithium source, the molybdenum source, and elemental molybdenum in powder form;
mixing the starting materials together; and
heating the mixed starting materials at a temperature sufficient to form a reaction product.

44. A method according to claim 42, wherein the heating step is carried out in an essentially non-oxidizing atmosphere.

45. A method according to claim 42, wherein the lithium source is selected from the group consisting of lithium carbonate, lithium phosphate, lithium hydrogen phosphate, lithium oxide, lithium hydroxide, lithium acetate, lithium oxalate, lithium nitrate, hydrates thereof, and combinations thereof.

46. A method according to claim 42, wherein the lithium source comprises lithium carbonate.

47. A method according to claim 42, wherein the molybdenum source comprises an oxide selected from the group consisting of molybdenum trioxide, molybdenum dioxide, and combinations thereof.

48. A method according to claim 42, wherein the final oxidation state is from +3 to +4.

49. A method according to claim 42, wherein the molybdenum source comprises the reaction product of a second molybdenum source and reducing carbon.

50. A composition comprising a molybdenum compound mixed together with elemental carbon, wherein the molybdenum compound and the elemental carbon are in the form of powders, and wherein the composition comprises a reaction product of a molybdenum starting material and reducing carbon.

51. A composition according to claim 50, wherein the molybdenum compound comprises molybdenum dioxide.

52. A composition according to claim 50, wherein the molybdenum starting material comprises molybdenum trioxide.

53. A composition according to claim 50, wherein the composition is prepared by a process comprising the steps of
providing as starting materials, a lithium source, a molybdenum source having molybdenum in an initial oxidation state, and elemental carbon in powder form, wherein the elemental carbon is present in stoichiometric excess;
mixing the starting materials together; and
heating the mixed starting materials at a temperature sufficient to form a reaction product comprising molybdenum in a final oxidation state lower than the initial oxidation state.

54. A composition according to claim 53, wherein the starting material comprises molybdenum trioxide.

55. A method for making a lithiated molybdenum oxide, comprising the step of reacting a composition of claim 50 with a lithium source.

56. A method according to claim 55, wherein the lithium source comprises lithium carbonate.
